(19) United States
(12) Patent Application Publication
(10) Pub. No.: US 2026/0315928 A1
(43) Pub. Date: Oct. 15, 2026

(54) OBJECT MOVEMENT CONTROL

(71) Applicant: TENCENT TECHNOLOGY (SHENZHEN) COMPANY LIMITED, Shenzhen (CN)

(72) Inventors: Xuelin CHEN, Shenzhen (CN); Rui CHEN, Shenzhen (CN); Mingyi SHI, Shenzhen (CN); Shaoli HUANG, Shenzhen (CN); Dongyue AN, Shenzhen (CN); Qi CHEN, Shenzhen (CN); Nan DU, Shenzhen (CN)

(73) Assignee: TENCENT TECHNOLOGY (SHENZHEN) COMPANY LIMITED, Shenzhen (CN)

(21) Appl. No.: 19/690,963

(22) Filed: May 28, 2026

Related U.S. Application Data
(63) Continuation of application No. PCT/CN2025/082505, filed on Mar. 14, 2025.

(30) Foreign Application Priority Data
Apr. 11, 2024 (CN) 202410437154.0

(51) Int. Cl. A63F 13/56; A63F 13/573; A63F 13/67; G06N 3/0455

(52) U.S. Cl. CPC A63F 13/56; A63F 13/573; A63F 13/67; G06N 3/0455

(57) ABSTRACT

In an object control method, a set of past motion parameters representing a past motion performed by a controlled object and a set of control parameters representing a motion expectation and a movement trajectory prediction for the controlled object are obtained. In the method, a set of noisy motion parameters is generated based on sampling a Gaussian noise. In the method, a set of expected motion parameters for a current motion prediction round is generated through a motion diffusion model based on the set of noisy motion parameters, the set of past motion parameters, and the set of control parameters. In the method, a current motion of the controlled object is controlled based on the set of expected motion parameters for the current motion prediction round. Apparatus and non-transitory computer-readable storage medium counterpart aspects are also contemplated.

### RELATED APPLICATIONS

The present application is a continuation of International Application No. PCT/CN2025/082505, filed on Mar. 14, 2025, which claims priority to Chinese Patent Application No. 202410437154.0, filed on Apr. 11, 2024, and entitled “OBJECT CONTROL METHOD AND APPARATUS, DEVICE, AND STORAGE MEDIUM.” The entire disclosures of the prior applications are hereby incorporated by reference.

### FIELD OF THE TECHNOLOGY

Embodiments of this disclosure relate to the field of human-computer interaction technologies, including an object control method and apparatus, a device, and a storage medium.

### BACKGROUND

A diffusion model is a generation model. The diffusion model may learn a noise distribution of noise added to original data in a forward noise adding process, and denoise noisy data in a backward diffusion process to obtain denoised data. A motion diffusion model (MDM) is a diffusion model that generates, by denoising a set of noisy motion parameters, a motion parameter usable to control a controlled object, where the motion parameter may be used to control a game character, a robot, and the like.

In a related technology, to generate a motion parameter by using a motion diffusion model, to control a controlled object (e.g., a virtual character in a virtual environment or a robot or unmanned vehicle in a real environment), a control target needs to be inputted into the motion diffusion model as a diffusion condition, so that a motion diffusion model outputs a set of expected motion parameters. The control target includes a motion type, a motion orientation, and the like. The motion parameter includes joint position coordinates and a joint rotation amount of the controlled object. For example, a non-player character (NPC) in a game usually needs to perform a specific task. In this case, a motion parameter usable to control the NPC to perform the task may be outputted by using a motion diffusion model. When the task is performed for a long time, the motion diffusion model needs to output long-duration motion parameters at a time.

However, outputting long-duration motion parameters at a time requires use of a motion diffusion model with a large quantity of parameters and high complexity, and has a high requirement on a model deployment condition.

### SUMMARY

Embodiments of this disclosure include an object control method and apparatus, a device, and a storage medium.

According to an aspect, an embodiment of this disclosure provides an object control method. In the method, a set of past motion parameters and a set of control parameters are obtained, the set of past motion parameters being from a previous motion prediction round and representing a past motion performed by a controlled object before a current motion prediction round, and the set of control parameters representing a motion expectation and a movement trajectory prediction for the controlled object in the current motion prediction round. In the method, a set of noisy motion parameters is generated by processing circuitry based on sampling a Gaussian noise. In the method, a set of expected motion parameters for the current motion prediction round is generated by the processing circuitry through a motion diffusion model based on the set of noisy motion parameters, the set of past motion parameters, and the set of control parameters. In the method, a current motion of the controlled object is controlled based on the set of expected motion parameters for the current motion prediction round.

According to an aspect, an embodiment of this disclosure provides an object control apparatus. The apparatus includes processing circuitry configured to obtain a set of past motion parameters and a set of control parameters, the set of past motion parameters being from a previous motion prediction round and representing a past motion performed by a controlled object before a current motion prediction round, and the set of control parameters representing a motion expectation and a movement trajectory prediction for the controlled object in the current motion prediction round. The processing circuitry is configured to generate a set of noisy motion parameters based on sampling a Gaussian noise. The processing circuitry is configured to generate a set of expected motion parameters for the current motion prediction round through a motion diffusion model based on the set of noisy motion parameters, the set of past motion parameters, and the set of control parameters. The processing circuitry is configured to control a current motion of the controlled object based on the set of expected motion parameters for the current motion prediction round.

According to an aspect, an embodiment of this disclosure provides a non-transitory computer-readable storage medium storing instructions, which when executed by a processor, cause the processor to perform an object control method. In the method, a set of past motion parameters and a set of control parameters are obtained, the set of past motion parameters being from a previous motion prediction round and representing a past motion performed by a controlled object before a current motion prediction round, and the set of control parameters representing a motion expectation and a movement trajectory prediction for the controlled object in the current motion prediction round. In the method, a set of noisy motion parameters is generated based on sampling a Gaussian noise. In the method, a set of expected motion parameters for the current motion prediction round is generated through a motion diffusion model based on the set of noisy motion parameters, the set of past motion parameters, and the set of control parameters. In the method, a current motion of the controlled object is controlled based on the set of expected motion parameters for the current motion prediction round.

According to an aspect, an embodiment of this disclosure provides an object control method. The method includes: obtaining a set of past motion parameters and a set of control parameters, the set of past motion parameters representing a past motion performed by a controlled object before a current motion prediction round, and the set of control parameters representing a motion expectation for the controlled object in the current motion prediction round; denoising, by using a motion diffusion model based on the set of past motion parameters and the set of control parameters, a set of noisy motion parameters sampled from Gaussian noise, to obtain a set of expected motion parameters for the current motion prediction round; and controlling the controlled object based on the set of expected motion parameters.

According to another aspect, an embodiment of this disclosure provides an object control apparatus. The apparatus includes: a parameter obtaining module, configured to obtain a set of past motion parameters and a set of control parameters, the set of past motion parameters representing a past motion performed by a controlled object before a current motion prediction round, and the set of control parameters representing a motion expectation for the controlled object in the current motion prediction round; a motion prediction module, configured to denoise, by using a motion diffusion model based on the set of past motion parameters and the set of control parameters, a set of noisy motion parameters sampled from Gaussian noise, to obtain a set of expected motion parameters for the current motion prediction round; and a control module, configured to control the controlled object based on the set of expected motion parameters.

According to another aspect, an embodiment of this disclosure provides a computer device. The computer device includes processing circuitry (e.g., a processor) and a memory (e.g., including a non-transitory computer-readable storage medium). The memory has at least one instruction stored therein. The at least one instruction is loaded and executed by the processor to implement the object control method described in the foregoing aspect.

According to another aspect, an embodiment of this disclosure provides a non-transitory computer-readable storage medium. The non-transitory readable storage medium has at least one instruction stored therein. The at least one instruction is loaded and executed by processing circuitry (e.g., a processor) to implement the object control method described in the foregoing aspect.

According to another aspect, an embodiment of this disclosure provides a computer program product. The computer program product includes at least one instruction. The at least one instruction is stored in a non-transitory computer-readable storage medium. Processing circuitry (e.g., a processor) of a computer device reads the at least one instruction from the non-transitory computer-readable storage medium. The processor executes the at least one instruction to enable the computer device to perform the object control method described in the foregoing aspect.

Details of one or more embodiments of this disclosure are provided in the following drawings and descriptions.

### BRIEF DESCRIPTION OF THE DRAWINGS

To describe the technical solutions in this disclosure, the following briefly describes the drawings for describing one or more embodiments of this disclosure. The drawings in the following descriptions show merely non-limiting examples of this disclosure, and a person of ordinary skill in the art may still derive other drawings from the disclosed drawings.

FIG. 1 is a block diagram of a structure of a computer system according to an embodiment of this disclosure.

FIG. 2 is a flowchart of an object control method according to an embodiment of this disclosure.

FIG. 3 is a flowchart of an object control method according to another embodiment of this disclosure.

FIG. 4 is a schematic diagram of a structure of a motion diffusion model according to an embodiment of this disclosure.

FIG. 5 is a flowchart of a trajectory expansion process according to an embodiment of this disclosure.

FIG. 6 is a schematic diagram of trajectory expansion according to an embodiment of this disclosure.

FIG. 7 is a flowchart of controlling a controlled object based on expected motion parameters for a plurality of rounds of motion prediction according to an embodiment of this disclosure.

FIG. 8 is a flowchart of a training method for a motion diffusion model according to an embodiment of this disclosure.

FIG. 9 is a schematic diagram of a structure of a motion diffusion model according to an embodiment of this disclosure.

FIG. 10 is a schematic diagram of application of an object control method to a game interaction scenario according to an embodiment of this disclosure.

FIG. 11 is a schematic diagram of application of an object control method to a robot control scenario according to an embodiment of this disclosure.

FIG. 12 is an effect comparison diagram when an object control method is applied to object control according to an embodiment of this disclosure.

FIG. 13 is an effect comparison diagram when an object control method is applied to object control according to another embodiment of this disclosure.

FIG. 14 is a block diagram of a structure of an object control apparatus according to an embodiment of this disclosure.

FIG. 15 is a schematic diagram of a structure of a computer device according to an embodiment of this disclosure.

### DETAILED DESCRIPTION

The following describes the technical solutions in embodiments of this disclosure with reference to the drawings in one or more embodiments of this disclosure. The described embodiments are merely some rather than all of embodiments of this disclosure. All other embodiments obtained by a person of ordinary skill in the art based on one or more embodiments of this disclosure shall fall within the scope of this disclosure.

Embodiments of this disclosure are described in further detail herein, and examples of one or more embodiments are described with reference to the drawings. When the following descriptions involve the drawings, unless otherwise denoted, the same numerals in different drawings denote the same or similar elements. Implementations described in the following one or more embodiments do not represent all implementations consistent with this disclosure. Instead, the implementations are merely examples of apparatuses and methods that are described in further detail in the appended claims and that are consistent with some aspects of this disclosure.

Terms used in this disclosure are merely for the purpose of describing corresponding embodiments, but are not intended to limit this disclosure. The terms “a/an”, “the”, and “this” of singular forms used in this disclosure and the appended claims are also intended to include plural forms, unless otherwise specified in the context. The term “and/or” used herein indicates and includes any or all possible combinations of one or more associated listed items.

Although the terms “first”, “second”, and the like may be used in this disclosure to describe various pieces of information, these pieces of information are not limited by the terms. These terms are merely used to differentiate the same type of information. For example, without departing from the scope of this disclosure, a first parameter may also be referred to as a second parameter, and similarly, a second parameter may also be referred to as a first parameter. Depending on the context, for example, the word “if” used herein may be interpreted as “while”, “when”, or “in response to determining.”

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

First, terms in one or more embodiments of this disclosure are briefly described. Descriptions of terms in this disclosure are provided as examples only and are not intended to limit the scope of the disclosure.
Past motion parameter: may represent a past motion performed by a controlled object before a current motion prediction round. In some embodiments, the past motion parameter may correspond to a set of motion parameters executed by the controlled object based on a result of a previous round of motion prediction, or may correspond to a set of motion parameters executed by the controlled object based on all past motion prediction results. During a first round of motion prediction, the set of past motion parameters may be set to zero.
Control parameter: may represent a motion expectation for a controlled object in a current motion prediction round. In some embodiments, the control parameter may correspond to a set of control parameters and may be determined based on a control instruction set by a user. The set of control parameters may include a displacement trajectory, a motion style, a motion orientation, and the like.
Motion style label: may indicate a motion style of a controlled object, for example, running, jumping on the left foot, or jumping on the right foot.
Root joint displacement trajectory (future root position): may indicate a movement trajectory of a controlled object. The root joint displacement trajectory may be a trajectory formed by coordinate points on a horizontal coordinate plane, and may indicate a projected displacement expectation for root joint coordinates of the controlled object on the horizontal coordinate plane.
Motion orientation (future root orient): may indicate a movement orientation of a controlled object, for example, forward, rightward, or northeastward.
Noisy motion parameter: When a motion diffusion model is applied to motion prediction, the noisy motion parameter may correspond to a set of noisy parameters obtained by sampling a Gaussian noise. When the motion diffusion model is trained, the noisy motion parameter may correspond to a set of noisy parameters obtained by performing noise adding on a motion parameter ground truth dataset.
Motion parameter ground truth dataset: may correspond to a set of ground truth motion parameter data usable for training a motion diffusion model. A single motion parameter ground truth dataset may include S frames of sample root joint coordinates and S frames of sample joint rotation parameters. One part of frames of the motion parameter ground truth dataset may be usable for generating a set of sample noisy motion parameters, and the other part of frames may be usable for calculating a model training loss.
Sample noisy motion parameter: may correspond to a set of sample noisy motion parameters generated based on a motion parameter ground truth dataset by performing noise adding on a part of frames of the motion parameter ground truth dataset, and may be used as a model input for performing denoising in a training process of a motion diffusion model, to obtain a set of sample motion parameters.
Motion diffusion model: may correspond to a deep learning framework combining a diffusion model principle and a motion generation task. The diffusion model may be a generation model. A core principle of the diffusion model may include learning a noise distribution of noise added to original data in a forward noise adding process, and denoising noisy data in a backward diffusion process to obtain denoised data. In a context of motion generation, the motion diffusion model uses this principle to generate a human body motion sequence matching a given text description.

In some aspects, Artificial intelligence (AI) may correspond to a theory, method, technology, and application system of simulating, extending, and developing human intelligence by using a digital computer or a machine controlled by a digital computer to perceive an environment, acquire knowledge, and obtain an optimal result by using the knowledge. In other words, artificial intelligence may correspond to a comprehensive technology in computer science, and may correspond to attempts to understand essence of intelligence and produce a new intelligent machine that can react in a manner similar to human intelligence. Artificial intelligence may correspond to research design principles and implementation methods of various intelligent machines, so that the machines have functions of perception, reasoning, and decision-making.

The artificial intelligence technology is a comprehensive discipline, and relates to a wide range of fields including both hardware-level technologies and software-level technologies. Basic artificial intelligence technologies may include technologies such as a sensor, a dedicated artificial intelligence chip, cloud computing, distributed storage, a big data processing technology, an operating/interaction system, and electromechanical integration. Artificial intelligence software technologies may include several directions such as a computer vision technology, a voice processing technology, a natural language processing technology, and machine learning/deep learning.

Machine learning (ML) may correspond to a multi-field interdisciplinary field, and may relate to a plurality of disciplines such as the probability theory, statistics, the approximation theory, convex analysis, and the algorithm complexity theory. Machine learning may specialize in studying how a computer simulates or implements a human learning behavior to obtain new knowledge or skills, and reorganize a knowledge structure, to keep improving performance of the computer. Machine learning may correspond to the core of artificial intelligence, may correspond to a basic way to make the computer intelligent, and may be applied to various fields of artificial intelligence. Machine learning and deep learning may include technologies such as an artificial neural network, a belief network, reinforcement learning, transfer learning, inductive learning, and learning from demonstrations.

With the research and progress of the artificial intelligence technology, the artificial intelligence technology is researched and applied to many fields, for example, common smart home, intelligent wearable devices, virtual assistants, intelligent speakers, intelligent marketing, unmanned driving, automatic driving, unmanned aerial vehicles, digital twins, virtual humans, robots, artificial intelligence generative content (AIGC), conversational interaction, intelligent medical, intelligent customer service, and game AI. With the development of the technology, the artificial intelligence technology will be applied to more fields and play an increasingly important role.

The solutions provided in one or more embodiments of this disclosure relate to artificial intelligence technologies such as machine learning, and are further described by using the following embodiments.

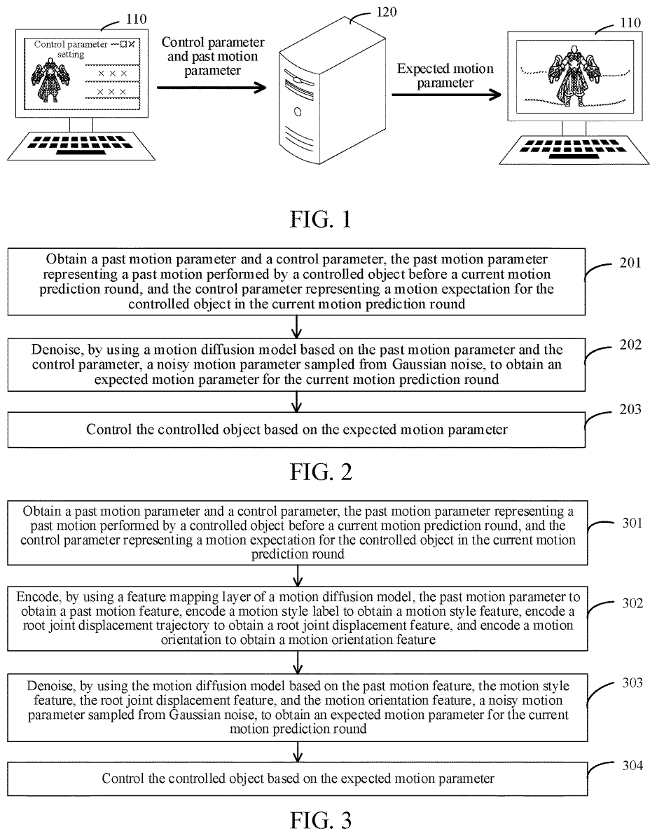

FIG. 1 is a schematic diagram of a structure of a computer system according to an embodiment of this disclosure. The computer system may include a terminal 110 and a server 120. The terminal 110 performs data communication with the server 120 by using a communication network. In some embodiments, the communication network may be a wired network or a wireless network. The communication network may be at least one of a local area network, a metropolitan area network, or a wide area network.

The terminal 110 is an electronic device on which an application having an object control function is installed. The object control function may be a function of a native application on the terminal or a function of a third-party application. The terminal may be a smartphone, a tablet computer, a notebook computer, a desktop computer, a smart television, a wearable device, an in-vehicle terminal, or the like. FIG. 1 shows an example in which the terminal 110 is a desktop computer as a non-limiting example.

The server 120 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. In this embodiment of this disclosure, the server 120 may be a background server of the application having the object control function.

In some embodiments, the server exchanges data with the terminal. For example, as shown in FIG. 1, when receiving a control instruction input by a user, the terminal 110 obtains a set of control parameters and a set of past motion parameters of a controlled object, and transmits the set of past motion parameters and the set of control parameters to the server 120. The server 120 denoises, by using a motion diffusion model based on the set of past motion parameters and the set of control parameters, a set of noisy motion parameters sampled from Gaussian noise, to obtain a set of expected motion parameters for a current motion prediction round. Further, the server 120 returns the set of expected motion parameters to the terminal 110. The terminal 110 controls the controlled object based on the set of expected motion parameters.

With reference to the foregoing brief descriptions, an object control method provided in this disclosure is described. The method may be performed by a server or a terminal, or may be jointly performed by a server and a terminal.

In some embodiments, in a case in which the method is performed by the terminal, when receiving a control instruction, the terminal obtains a set of control parameters and a set of past motion parameters of a controlled object, denoises, by using a motion diffusion model based on the set of control parameters and the set of past motion parameters, a set of noisy motion parameters sampled from Gaussian noise, to obtain a set of expected motion parameters for a current motion prediction round, and controls the controlled object based on the set of expected motion parameters.

In some embodiments, in a case in which the method is jointly performed by the server and the terminal, when receiving a control instruction transmitted by the terminal, the server obtains a set of control parameters and a set of past motion parameters of a controlled object, denoises, by using a motion diffusion model based on the set of control parameters and the set of past motion parameters, a set of noisy motion parameters sampled from Gaussian noise, to obtain a set of expected motion parameters for a current motion prediction round, and returns the set of expected motion parameters to the terminal. The terminal controls the controlled object based on the set of expected motion parameters.

FIG. 2 is a flowchart of an object control method according to an embodiment of this disclosure. An example in which the method is applied to a computer device (including a terminal and/or a server) is used for description in this embodiment. The method includes the following operations.

Operation 201: Obtain a set of past motion parameters and a set of control parameters, the set of past motion parameters representing a past motion performed by a controlled object before a current motion prediction round, and the set of control parameters representing a motion expectation for the controlled object in the current motion prediction round. For example, a set of past motion parameters and a set of control parameters are obtained, the set of past motion parameters being from a previous motion prediction round and representing a past motion performed by a controlled object before a current motion prediction round, and the set of control parameters representing a motion expectation and a movement trajectory prediction for the controlled object in the current motion prediction round.

In some embodiments, the controlled object may be a virtual character in a game, or may be a robot or the like. This is not limited in embodiments of this disclosure.

The control parameter represents the motion expectation for the controlled object in the current motion prediction round. In some embodiments, the set of control parameters may include a displacement trajectory, a motion style, a motion orientation, and the like.

In a possible implementation, when receiving a control instruction input by a user, the computer device determines the set of control parameters based on the control instruction. For example, in a game scenario, when a control instruction “run forward” input by the user is received, the computer device may determine that a motion type is running and the motion orientation is forward.

In some embodiments, in a process of implementing segmental control on the controlled object, in addition to performing motion prediction based on the set of control parameters, the computer device further needs to obtain the set of past motion parameters of the controlled object, to improve continuity of motions of the controlled object before and after each round of motion prediction.

The past motion parameter represents the past motion performed by the controlled object before the current motion prediction round. In some embodiments, the set of past motion parameters may be a motion parameter executed by the controlled object based on a result of a previous round of motion prediction, or may be a motion parameter executed by the controlled object based on all past motion prediction results. During first motion prediction, the set of past motion parameters is zero.

In some embodiments, skeletal joints of the controlled object may be classified as root joints and other joints according to attributes of joints of the controlled object and connections between the joints. The other joints include an arm joint, a leg joint, and the like. The motion parameter includes root joint coordinates and each joint rotation parameter. The past motion parameter is root joint coordinates and joint rotation parameters when the controlled object performs a motion before the current motion prediction round.

In a possible implementation, before controlling the controlled object, the computer device first constructs, based on initial root joint coordinates of the controlled object by using the initial root joint coordinates as a coordinate origin and a front direction of the controlled object as a longitudinal-axis direction, a joint coordinate system corresponding to the controlled object, to determine joint coordinates and a joint rotation amount of each other joint of the controlled object based on the joint coordinate system.

The joint coordinate system is a coordinate system constructed by the computer device based on the initial root joint coordinates of the controlled object by using the initial root joint coordinates as the coordinate origin and the front direction of the controlled object as the longitudinal-axis direction, to determine the joint coordinates and the joint rotation amount of each other joint of the controlled object.

Operation 202: Denoise, by using a motion diffusion model based on the set of past motion parameters and the set of control parameters, a set of noisy motion parameters sampled from Gaussian noise, to obtain a set of expected motion parameters for the current motion prediction round. For example, a set of noisy motion parameters is generated by processing circuitry based on sampling a Gaussian noise. In some examples, a set of expected motion parameters for the current motion prediction round is generated by the processing circuitry through a motion diffusion model based on the set of noisy motion parameters, the set of past motion parameters, and the set of control parameters.

In some embodiments, after obtaining the set of past motion parameters and the set of control parameters, the computer device may denoise, by using the motion diffusion model based on the set of past motion parameters and the set of control parameters, the set of noisy motion parameters sampled from the Gaussian noise, to obtain the set of expected motion parameters for the current motion prediction round.

The noisy motion parameter may be obtained by sampling the Gaussian noise. In a possible implementation, the computer device determines a feature dimension and a quantity of frames for noise sampling based on a parameter feature of the set of past motion parameters and a quantity of frames for motion prediction in the current motion prediction round, and samples the Gaussian noise based on the feature dimension and the quantity of frames, to obtain the set of noisy motion parameters with a same feature dimension and a corresponding quantity of frames.

In some embodiments, to optimize a denoising effect, the computer device further needs to determine a diffusion timestep, and denoise the set of noisy motion parameters by using the motion diffusion model based on the diffusion timestep, to obtain the set of expected motion parameters for the current motion prediction round. For example, if the diffusion timestep is 8, the computer device needs to perform denoising of eight diffusion timesteps on the set of noisy motion parameters by using the motion diffusion model based on the set of past motion parameters and the set of control parameters, to obtain the set of expected motion parameters. The diffusion timestep is a quantity of timesteps for denoising of the set of noisy motion parameters by the motion diffusion model.

In some embodiments, a plurality of frames of expected motion parameters may be predicted for each motion prediction round. The expected motion parameters include each frame of joint displacement parameter and each frame of joint rotation parameter, where the joint displacement parameter represents joint position coordinates for the current frame, and the joint rotation parameter represents a joint rotation angle for the current frame.

Operation 203: Control the controlled object based on the set of expected motion parameters. For example, a current motion of the controlled object is controlled based on the set of expected motion parameters for the current motion prediction round.

In some embodiments, after obtaining the set of expected motion parameters for the current motion prediction round, the computer device may control the controlled object based on the set of expected motion parameters.

In some embodiments, when the set of expected motion parameters includes a plurality of frames of joint displacement parameters and a plurality of frames of joint rotation parameters, the computer device may control, based on each frame of joint displacement parameter and each frame of joint rotation parameter, the controlled object to perform a motion in the corresponding frame.

In one or more embodiments of this disclosure, in a process of predicting a motion parameter by using the motion diffusion model, one-time output of long-duration motion parameters is converted into output of short-duration motion parameters in a plurality of rounds. This shortens duration corresponding to a motion parameter that needs to be generated each time, so that a requirement on a quantity of model parameters of the motion diffusion model is reduced, reducing a requirement on a model deployment condition. Moreover, in addition to the set of control parameters, the set of past motion parameters is added as a diffusion condition, and during each round of motion prediction, reference is made to a past motion previously performed by the controlled object. This improves continuity between motions during staged output, and improves output quality of the long-duration motion parameters.

In some embodiments, the set of control parameters may include a motion style label, a root joint displacement trajectory, and a motion orientation. For parameter features of different control parameters, the computer device may perform corresponding processing on the model parameter in a motion prediction process, to improve accuracy of motion prediction implemented by the motion diffusion model based on the set of control parameters.

FIG. 3 is a flowchart of an object control method according to another embodiment of this disclosure. An example in which the method is applied to a computer device (including a terminal and/or a server) is used for description in this embodiment. The method includes the following operations.

Operation 301: Obtain a set of past motion parameters and a set of control parameters, the set of past motion parameters representing a past motion performed by a controlled object before a current motion prediction round, and the set of control parameters representing a motion expectation for the controlled object in the current motion prediction round.

In some aspects, operation 301 may be implemented based on operation 201 described in this disclosure. Details may be simplified or omitted and thus may not be described again.

In some embodiments, the set of control parameters may include a motion style label, a root joint displacement trajectory, and a motion orientation. The motion style label may indicate a motion style of the controlled object, for example, running, jumping on the left foot, or jumping on the right foot. The root joint displacement trajectory may indicate a movement trajectory of the controlled object. The root joint displacement trajectory may be a trajectory formed by coordinate points on a horizontal coordinate plane, and may indicate a projected displacement expectation for root joint coordinates of the controlled object on the horizontal coordinate plane. The motion orientation may indicate a movement orientation of the controlled object, for example, forward or rightward.

In a possible implementation, a motion orientation for a first round of motion prediction may be determined based on a control instruction input by a user, and a root joint displacement trajectory may be generated based on the motion orientation. For example, if the motion orientation is moving rightward, the root joint displacement trajectory may be a rightward straight line.

Operation 302: Encode, by using a feature mapping layer of the motion diffusion model, the set of past motion parameters to obtain a past motion feature, encode the motion style label to obtain a motion style feature, encode the root joint displacement trajectory to obtain a root joint displacement feature, and encode the motion orientation to obtain a motion orientation feature.

In some embodiments, the motion diffusion model includes the feature mapping layer and a motion prediction network. In some embodiments, after inputting the set of past motion parameters, the motion style label, the root joint displacement trajectory, and the motion orientation into the motion diffusion model, the computer device may separately encode the set of past motion parameters, the motion style label, the root joint displacement trajectory, and the motion orientation by using the feature mapping layer of the motion diffusion model, to obtain the past motion feature, the motion style feature, the root joint displacement feature, and the motion orientation feature.

The feature mapping layer is a component of the motion diffusion model, and may separately encode the inputted past motion parameter, motion style label, root joint displacement trajectory, and motion orientation to obtain the corresponding past motion feature, motion style feature, root joint displacement feature, and motion orientation feature. In some embodiments, the feature mapping layer is a linear layer. To avoid coupling between different features or some feature components dominating, a plurality of feature mapping layers may be disposed in the motion diffusion model, and different inputs correspond to different feature mapping layers.

The motion prediction network is a component of the motion diffusion model, receives the past motion feature, the motion style feature, the root joint displacement feature, and the motion orientation feature that are obtained by the feature mapping layer by encoding the set of past motion parameters, the motion style label, the root joint displacement trajectory, and the motion orientation, and uses these features as diffusion conditions for denoising a set of noisy motion parameters to obtain a set of expected motion parameters.

In some embodiments, the feature mapping layer may be a linear layer. In addition, to avoid coupling between different features during a feature mapping process or some feature components accidentally dominating, the motion diffusion model may include a plurality of feature mapping layers, and the set of past motion parameters, the motion style label, the root joint displacement trajectory, and the motion orientation respectively correspond to different feature mapping layers.

In a possible implementation, the computer device respectively inputs the set of past motion parameters, the motion style label, the root joint displacement trajectory, and the motion orientation into the corresponding feature mapping layers, to perform feature encoding by using the corresponding feature mapping layers, to obtain the past motion feature, the motion style feature, the root joint displacement feature, and the motion orientation feature.

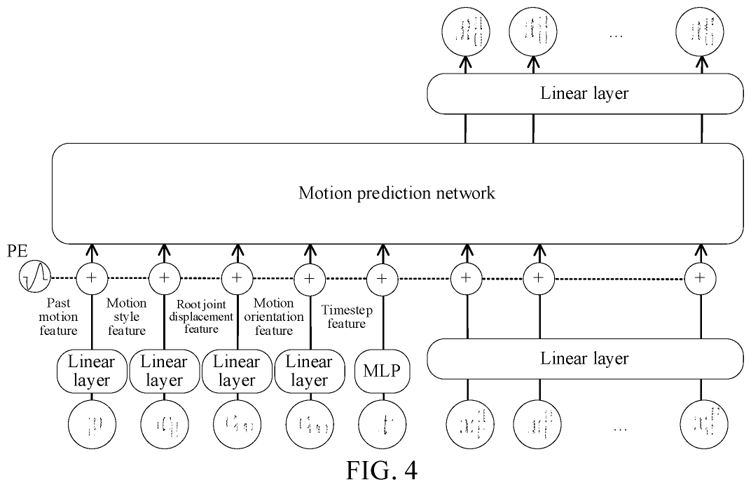

For example, as shown in FIG. 4, the motion diffusion model includes a plurality of linear layers and a motion prediction network. The computer device respectively inputs the set of past motion parameters p, the motion style label cₗ, the root joint displacement trajectory cᵣᵥ, and the motion orientation cᵣₒ into corresponding linear layers, to perform feature encoding by using the corresponding linear layers, to obtain the past motion feature, the motion style feature, the root joint displacement feature, and the motion orientation feature.

Operation 303: Denoise, by using the motion diffusion model based on the past motion feature, the motion style feature, the root joint displacement feature, and the motion orientation feature, the set of noisy motion parameters sampled from Gaussian noise, to obtain the set of expected motion parameters for the current motion prediction round.

In some embodiments, after completing feature encoding, the computer device may denoise the set of noisy motion parameters by using the motion diffusion model based on the past motion feature, the motion style feature, the root joint displacement feature, and the motion orientation feature, to obtain the set of expected motion parameters for the current motion prediction round.

In a possible implementation, the computer device inputs the past motion feature, the motion style feature, the root joint displacement feature, and the motion orientation feature into the motion prediction network of the motion diffusion model as the diffusion conditions, and denoises the set of noisy motion parameters by using the motion prediction network, to obtain the set of expected motion parameters.

In a possible implementation, the motion diffusion model further includes a multi-layer perceptron (MLP). When a diffusion timestep is set, the computer device may perform feature encoding on the diffusion timestep by using the MLP, to obtain a timestep feature, and denoise the set of noisy motion parameters based on the timestep feature. The MLP is a part of the motion diffusion model, and when the diffusion timestep is set, may perform feature encoding on the diffusion timestep to obtain the timestep feature, and denoise the set of noisy motion parameters based on the timestep feature. The timestep feature is a feature obtained by the MLP by performing feature encoding on the diffusion timestep. The feature may be used by the motion diffusion model to denoise the set of noisy motion parameters based on the past motion feature, the motion style feature, the root joint displacement feature, the motion orientation feature, and the like, to obtain the set of expected motion parameters.

For example, as shown in FIG. 4, the computer device performs feature encoding on the diffusion timestep t by using the MLP, to obtain the timestep feature, and denoises F frames of noisy motion parameters

$${x}_{t}^{1} ∼ {x}_{t}^{F}$$

based on the timestep feature, to obtain expected motion parameters

$${\hat{x}}_{0}^{1} ∼ {\hat{x}}_{0}^{F}$$

for the current motion prediction round.

In some embodiments, in a motion prediction and control process, not only continuity between rounds of motion prediction is improved by using the set of past motion parameters, but also the motion style or the motion orientation is adjusted by using the set of control parameters. In other words, the set of control parameters may change significantly between adjacent motion prediction rounds, for example, the motion style is switched from jumping on the left foot to jumping on the right foot. Therefore, to implement smooth transition of the motion style, when the motion style is switched, the computer device may reduce influence of the set of past motion parameters in the motion prediction process based on a motion sampling principle of classifier-free guidance (CFG). The classifier-free guidance is a principle for motion sampling. In this disclosure, when the motion style label changes between adjacent motion prediction rounds, to implement smooth transition of the motion style, the computer device may reduce, according to this principle, the influence of the set of past motion parameters in the motion prediction process.

In some examples, generating the set of expected motion parameters for the current motion prediction round includes determining whether the motion style label for the current motion prediction round is consistent with a previous motion style label for the previous motion prediction round. In some examples, the obtaining the set of expected motion parameters for the current motion prediction round includes determining the first set of denoised motion parameters as the set of expected motion parameters for the current motion prediction round when the motion style label is determined as consistent with the previous motion style label. In some examples, the generating the set of expected motion parameters for the current motion prediction round includes denoising the set of noisy motion parameters through the motion diffusion model based on the past motion feature being set to zero, the motion style feature, the root joint displacement feature, and the motion orientation feature, to obtain a second set of denoised motion parameters when the motion style label is determined as inconsistent with the previous motion style label. In some examples, the generating the set of expected motion parameters for the current motion prediction round includes determining the set of expected motion parameters for the current motion prediction round based on the first set of denoised motion parameters and the second set of denoised motion parameters when the motion style label is determined as inconsistent with the previous motion style labels.

In a possible implementation, before performing the current round of motion prediction, the computer device may first compare the motion style label for the current motion prediction round with a motion style label for a previous motion prediction round. Further, when the motion style label for the current motion prediction round is consistent with the motion style label for the previous motion prediction round, the computer device may directly denoise, by using the motion diffusion model based on the past motion feature, the motion style feature, the root joint displacement feature, and the motion orientation feature, the set of noisy motion parameters sampled from the Gaussian noise, to obtain the set of expected motion parameters for the current motion prediction round.

In some embodiments, the set of past motion parameters may be represented as p, the motion style label may be represented as cₗ, the root joint displacement trajectory may be represented as cᵣᵥ, the motion orientation may be represented as cᵣₒ, the diffusion timestep may be represented as t, the set of noisy motion parameters may be represented as xₜ, and the process of denoising, by using the motion diffusion model, the set of noisy motion parameters sampled from the Gaussian noise, to obtain the set of expected motion parameters may be represented as \hat{x}₀=G(xₜ, t; p, cₗ, cᵣᵥ, cᵣₒ).

When the motion style label for the current motion prediction round is inconsistent with the motion style label for the previous motion prediction round, to reduce the influence of the set of past motion parameters in the motion prediction process, the computer device may denoise the set of noisy motion parameters twice by using the motion diffusion model based on the past motion feature, the motion style feature, the root joint displacement feature, and the motion orientation feature, to obtain two denoising results, the past motion feature being set to zero in one denoising process; and determine the set of expected motion parameters for the current motion prediction round based on the two denoising results.

In a possible implementation, when the motion style label for the current motion prediction round is inconsistent with the motion style label for the previous motion prediction round, the computer device may first denoise, by using the motion diffusion model based on the past motion feature, the motion style feature, the root joint displacement feature, and the motion orientation feature, the set of noisy motion parameters sampled from the Gaussian noise, to obtain a first set of candidate motion parameters (or a first set of denoised motion parameters), then set the past motion feature to zero, denoise, by using the motion diffusion model based on, for example based on only, the motion style feature, the root joint displacement feature, and the motion orientation feature, the set of noisy motion parameters sampled from the Gaussian noise, to obtain a second set of candidate motion parameters (or a second set of denoised motion parameters), and finally fuse the first set of candidate motion parameters and the second set of candidate motion parameters to obtain the set of expected motion parameters for the current motion prediction round.

In some embodiments, after obtaining the first set of candidate motion parameters and the second set of candidate motion parameters, the computer device may determine a motion parameter difference based on the first set of candidate motion parameters and the second set of candidate motion parameters, determine a motion style guidance of the motion style label for the current motion prediction round based on the motion parameter difference and a guidance ratio, and determine the set of expected motion parameters for the current motion prediction round based on the second set of candidate motion parameters and the motion style guidance.

The motion parameter difference is a difference between the first set of candidate motion parameters and the second set of candidate motion parameters that are obtained by denoising the set of noisy motion parameters twice by using the motion diffusion model when the motion style label for the current motion prediction round is inconsistent with the motion style label for the previous motion prediction round. The motion style guidance of the motion style label for the current motion prediction round may be determined based on the difference.

The guidance ratio may adjust a degree of influence of the first set of candidate motion parameters on the set of expected motion parameters. The motion style guidance is the influence of the first set of candidate motion parameters on the set of expected motion parameters.

The motion style guidance is the influence of the first set of candidate motion parameters on the set of expected motion parameters, is determined based on the motion parameter difference and the guidance ratio when the motion style label for the current motion prediction round is inconsistent with the motion style label for the previous motion prediction round. In some aspects, the set of expected motion parameters for the current motion prediction round may be determined based on the motion style guidance and the second set of candidate motion parameters.

In a possible implementation, after obtaining the first set of candidate motion parameters and the second set of candidate motion parameters, the computer device may subtract the second set of candidate motion parameters from the first set of candidate motion parameters to obtain the motion parameter difference, then multiply the guidance ratio by the motion parameter difference to adjust the degree of the influence of the first set of candidate motion parameters on the set of expected motion parameters to obtain the motion style guidance, and add the second set of candidate motion parameters to the motion style guidance to obtain the set of expected motion parameters.

A lower guidance ratio indicates a smaller degree of the influence of the first set of candidate motion parameters on the set of expected motion parameters, a smaller motion style guidance, a closer proximity of the set of expected motion parameters to the second set of candidate motion parameters, and less influence of the set of past motion parameters on the set of expected motion parameters.

In some embodiments, when the motion style label for the current motion prediction round is inconsistent with the motion style label for the previous motion prediction round, a process of determining the set of expected motion parameters may be represented as \hat{x}₀=G(xₜ, t; p, cₗ, cᵣᵥ, cᵣₒ)=G(xₜ, t; p=Ø, cₗ, cᵣᵥ, cᵣₒ)+γ(G(xₜ, t; p, cₗ, cᵣᵥ, cᵣₒ)−G(xₜ, t; p=Ø, cₗ, cᵣᵥ, cᵣₒ)). γ is the guidance ratio, and γ may be preset. Ø is an empty set, and p=Ø represents that the set of past motion parameters p is set to zero.

The guidance ratio γ may be preset based on an actual application scenario and an experimental result, and is usually valued from 0 to 1. A value of γ indicates a smaller degree of the influence of the first set of candidate motion parameters on the set of expected motion parameters, a smaller motion style guidance, a closer proximity of the set of expected motion parameters to the second set of candidate motion parameters, and less influence of the set of past motion parameters on the set of expected motion parameters. Alternatively, the guidance ratio may be determined based on a model training situation. For example, a large guidance ratio is set in an early stage of model training, and the guidance ratio is gradually reduced as training is performed.

Operation 304: Control the controlled object based on the set of expected motion parameters.

In a possible implementation, the computer device predicts N frames of expected motion parameters for each round of motion prediction, that is, predicts 1^{st} to N^{th} frames of expected motion parameters for a 1^{st} round of motion prediction, predicts (N+1)^{th} to (2N)^{th} frames of expected motion parameters for a 2^{nd} round of motion prediction, and so on, to obtain expected motion parameters corresponding to each round of motion prediction. In addition, after each round of motion prediction, the computer device controls, based on the N frames of expected motion parameters, the controlled object to perform N frames of motions.

In some embodiments, N frames of expected motion parameters are predicted for the current motion prediction round, and the set of expected motion parameters include N frames of target root joint coordinates and N frames of joint rotation parameters. Therefore, the computer device controls, based on the N frames of target root joint coordinates and the N frames of joint rotation parameters, the controlled object to perform N frames of motions.

In some embodiments, the target root joint coordinates are a component of the set of expected motion parameters, and may be represented as O∈R^{F×3}, where F represents a quantity of motion prediction frames, O represents the target root joint coordinates, and R represents a real number set. The target root joint coordinates indicate a target coordinate position of a root joint of the controlled object, and together with the joint rotation parameter, may be used to control the controlled object to perform a corresponding motion. The joint rotation parameter is a component of the set of expected motion parameters, and may be represented as P∈R^{F×JQ}, where F represents the quantity of motion prediction frames, J represents a quantity of joints, Q represents a quantity of rotation features, P represents the joint rotation parameter, and R represents a real number set. The joint rotation parameter and the target root joint coordinates may together be used to control the controlled object to perform the corresponding motion.

In the foregoing embodiment, the plurality of feature mapping layers are disposed in the motion diffusion model, to respectively perform independent feature encoding on the set of past motion parameters, the motion style label, the root joint displacement trajectory, and the motion orientation in the motion prediction process. This avoids coupling between features or a feature imbalance, and improves effectiveness of each feature, thereby improving motion prediction stability and accuracy.

In addition, segmental motion prediction can adjust the set of control parameters in time based on a control requirement during each round of motion prediction, and change the motion style label or adjust the motion orientation, improving object control flexibility and improving style diversity of motion prediction.

In addition, when the motion style label changes between two adjacent motion prediction rounds, the set of noisy motion parameters is denoised twice by using the motion diffusion model, and the set of past motion parameters is set to zero in one denoising process, so that the set of expected motion parameters for the current motion prediction round is determined based on the two denoising results. This can reduce the influence of the set of past motion parameters on a current motion prediction result, make motion prediction closer to the motion style indicated by the current motion style label, and further improve the motion prediction accuracy.

In some embodiments, in a process of implementing object control through segmental motion prediction, there may be a significant difference between control parameters for two motion prediction rounds, including switching of the motion style and a sudden change in the motion orientation. However, when N frames of expected motion parameters are predicted for each round, if these N frames of expected motion parameters are used to control the controlled object, motion jitter of the controlled object between the adjacent motion prediction rounds may be caused, resulting in a poor control effect. Therefore, to improve prediction continuity of motion parameters between the adjacent motion prediction rounds, the computer device may control the controlled object based on, for example based on only, first M (M is less than N) frames of target root joint coordinates and first M frames of joint rotation parameters in the N frames of expected motion parameters, and determine a root joint displacement trajectory for a next motion prediction round based on last N−M frames of target root joint coordinates.

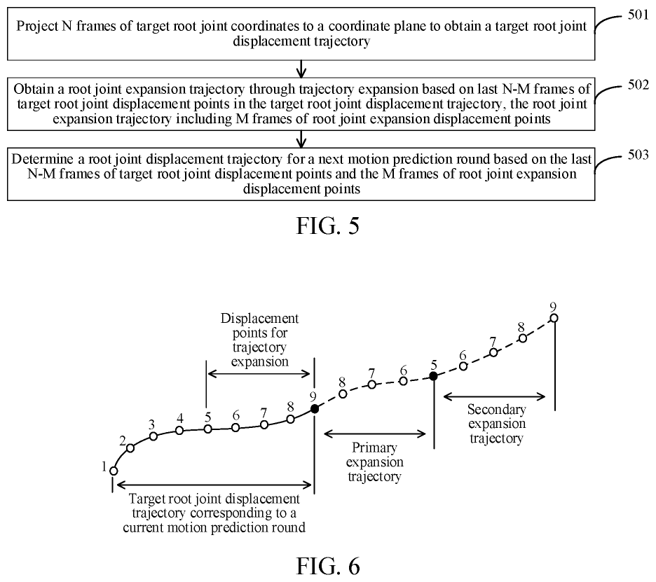

In some embodiments, as shown in FIG. 5, a process of determining the root joint displacement trajectory for the next motion prediction round based on the last N−M frames of target root joint coordinates may include the following operations.
Operation 501: Project the N frames of target root joint coordinates to a coordinate plane to obtain a target root joint displacement trajectory.

In a possible implementation, after obtaining the set of expected motion parameters for the current motion prediction round, the computer device may project the N frames of target root joint coordinates to the horizontal coordinate plane to obtain the target root joint displacement trajectory for the current motion prediction round.

Coordinate projection is an operation of projecting the N frames of target root joint coordinates to the coordinate plane (for example, the horizontal coordinate plane). The target root joint displacement trajectory may be obtained through this operation. For example, a coordinate value of the target root joint coordinates in a Z-axis direction is set to zero, and the target root joint displacement trajectory is obtained based on a projected displacement point of each frame of target root joint coordinates in an XY plane.

In some embodiments, the computer device may set the coordinate value of the target root joint coordinates in the Z-axis direction to zero, thereby obtaining the target root joint displacement trajectory based on the projected displacement point of each frame of target root joint coordinates in the XY plane.

For example, as shown in FIG. 6, nine frames of target root joint coordinates are predicted for the current motion prediction round, and the target root joint displacement trajectory may be obtained by projecting the nine frames of target root joint coordinates to the horizontal coordinate plane.
Operation 502: Obtain a root joint expansion trajectory through trajectory expansion based on last N−M frames of target root joint displacement points in the target root joint displacement trajectory, the root joint expansion trajectory including M frames of root joint expansion displacement points.

In a possible implementation, because first M frames of target root joint coordinates have been used to control the controlled object, to improve diversity of motion prediction, the computer device may determine the root joint expansion trajectory through trajectory expansion based on, for example based on only, the last N−M frames of target root joint displacement points in the target root joint displacement trajectory, the root joint expansion trajectory including the M frames of root joint expansion displacement points.

Trajectory expansion is a process of generating the root joint expansion trajectory based on the last N−M frames of target root joint displacement points in the target root joint displacement trajectory. For example, symmetry points of an (N−1)^{th} frame of target root joint displacement point to an (N−L)^{th} frame of target root joint displacement point are determined by using an N^{th} frame of target root joint displacement point in the last N−M frames of target root joint displacement points as a central symmetry point, to obtain (N+1)^{th} to (N+L)^{th} frames of root joint expansion displacement points (L is less than N−M), to further generate the root joint expansion trajectory. Expansion may be performed for a plurality of times when necessary, to obtain an adequate quantity of root joint expansion displacement points.

The root joint expansion trajectory is a trajectory obtained through trajectory expansion, includes the M frames of root joint expansion displacement points, and together with the last N−M frames of target root joint displacement points, may be used to determine the root joint displacement trajectory for the next motion prediction round.

In some embodiments, the computer device determines, in the last N−M frames of target root joint displacement points, the symmetry points of the (N−1)^{th} frame of target root joint displacement point to the (N−L)^{th} frame of target root joint displacement point by using the N^{th} frame of target root joint displacement point as the central symmetry point, to obtain the (N+1)^{th} to (N+L)^{th} frames of root joint expansion displacement points, L being less than N−M, thereby generating the root joint expansion trajectory based on the (N+1)^{th} to (N+L)^{th} frames of root joint expansion displacement points.

Regarding an expansion displacement point determining process, in a possible implementation, the computer device may construct a local coordinate system by using the N^{th} frame of target root joint displacement point as a coordinate origin and a tangent direction and a direction perpendicular to a tangent of a target root joint displacement trajectory between the N^{th} and (N−1)^{th} frames as coordinate axes, and determine, in the local coordinate system, the symmetry points of the (N−1)^{th} frame of target root joint displacement point to the (N−L)^{th} frame of target root joint displacement point by using the coordinate origin as the central symmetry point, thereby obtaining the (N+1)^{th} to (N+L)^{th} frames of root joint expansion displacement points.

In a possible implementation, when L is less than M, the root joint expansion trajectory including the M frames of root joint expansion displacement points may not be obtained based on, for example based on only, the (N+1)^{th} to (N+L)^{th} frames of root joint expansion displacement points alone, that is, a single trajectory expansion may be inadequate. Therefore, to obtain as many root joint expansion displacement points as possible, after completing a trajectory expansion, the computer device may further determine symmetry points of an (N+L−1)^{th} frame of root joint expansion displacement point to the N^{th} frame of target root joint displacement point by using an (N+L)^{th} frame of root joint expansion displacement point as a central symmetry point, to obtain (N+L+1)^{th} to (N+2L)^{th} frames of root joint expansion displacement points.

Further, when 2L is greater than M, the computer device may generate, based on the (N+1)^{th} to (N+2L)^{th} frames of root joint expansion displacement points, the root joint expansion trajectory including the M frames of root joint expansion displacement points. However, when 2L is less than M, the computer device needs to perform trajectory expansion again according to the foregoing displacement point expansion manner, until a quantity of root joint expansion displacement points is greater than M.

For example, referring to FIG. 6, the target root joint displacement trajectory generated based on the set of expected motion parameters for the current motion prediction round includes the 1^{st} to 9^{th} target root joint displacement points, where the last five target root joint displacement points may be used for trajectory expansion. Therefore, the computer device determines root joint expansion displacement points corresponding to the 5^{th} to 8^{th} target root joint displacement points by using the 9^{th} target root joint displacement point as a central symmetry point, to complete a primary trajectory expansion. Further, the computer device determines, by using the root joint expansion displacement point corresponding to the 5^{th} target root joint displacement point as a central symmetry point, secondary root joint expansion displacement points corresponding to the 9^{th} target root joint displacement point and the root joint expansion displacement points corresponding to the 6^{th} to 8^{th} target root joint displacement points, to complete a secondary trajectory expansion.
Operation 503: Determine the root joint displacement trajectory for the next motion prediction round based on the last N−M frames of target root joint displacement points and the M frames of root joint expansion displacement points.

In some embodiments, after obtaining the root joint expansion trajectory, the computer device may determine the root joint displacement trajectory for the next motion prediction round based on the last N−M frames of target root joint displacement points, the M frames of root joint expansion displacement points, and a frame number corresponding to each displacement point.

For example, as shown in FIG. 6, after controlling the controlled object based on the 1^{st} to 4^{th} frames of target root joint coordinates, the computer device may perform trajectory expansion by using the 5^{th} to 9^{th} frames of target root joint displacement points, to determine, by using the 9^{th} frame of target root joint displacement point as the central symmetry point, the root joint expansion displacement points corresponding to the 5^{th} to 8^{th} frames of target root joint displacement points, to obtain four frames (10^{th} to 13^{th} frames) of root joint expansion displacement points, so that the computer device may generate the root joint displacement trajectory for the next motion prediction round based on the 5^{th} to 9^{th} frames of target root joint displacement points and the 10^{th} to 13^{th} frames of root joint expansion displacement points. In some embodiments, considering that the motion orientation may change in the next motion prediction round, and the motion orientation may also affect the root joint displacement trajectory, to optimize the root joint displacement trajectory for the next motion prediction round, the computer device may further adjust the root joint displacement trajectory with reference to a motion orientation for the next motion prediction round.

In a possible implementation, after obtaining the root joint expansion trajectory including the M frames of root joint expansion displacement points, the computer device first generates a first candidate root joint displacement trajectory for the next motion prediction round based on the last N−M frames of target root joint displacement points and the M frames of root joint expansion displacement points, generates a second candidate root joint displacement trajectory for the next motion prediction round based on the motion orientation for the next motion prediction round, and finally obtains the root joint displacement trajectory for the next motion prediction round through trajectory fusion with reference to the first candidate root joint displacement trajectory and the second candidate root joint displacement trajectory.

Trajectory fusion is an operation of generating the root joint displacement trajectory for the next motion prediction round with reference to the first candidate root joint displacement trajectory based on the last N−M frames of target root joint displacement points and the M frames of root joint expansion displacement points and the second candidate root joint displacement trajectory generated based on the motion orientation for the next motion prediction round. For example, the root joint displacement trajectory for the next motion prediction round is generated by calculating an average value of displacement point coordinates of each frame.

Regarding a trajectory fusion process, in a possible implementation, the computer device may calculate the average value of the displacement point coordinates of each frame based on first displacement point coordinates in the first candidate root joint displacement trajectory and second displacement point coordinates in the second candidate root joint displacement trajectory, and then generate the root joint displacement trajectory for the next motion prediction round based on the average value of the displacement point coordinates.

In the foregoing embodiment, after the N frames of expected motion parameters are obtained through one motion prediction, not all the frames of expected motion parameters are directly applied to object control, and instead, the controlled object is controlled based on the first M frames of expected motion parameters. The root joint displacement trajectory for the next motion prediction round is generated through coordinate projection and trajectory expansion based on the target root joint coordinates in the last N−M frames of expected motion parameters, and the root joint displacement trajectory is used as an input of the motion diffusion model for the next round of motion prediction. This can reduce a problem of motion jitter existing in a motion execution process, and improve continuity of motions of the controlled object between two motion predictions.

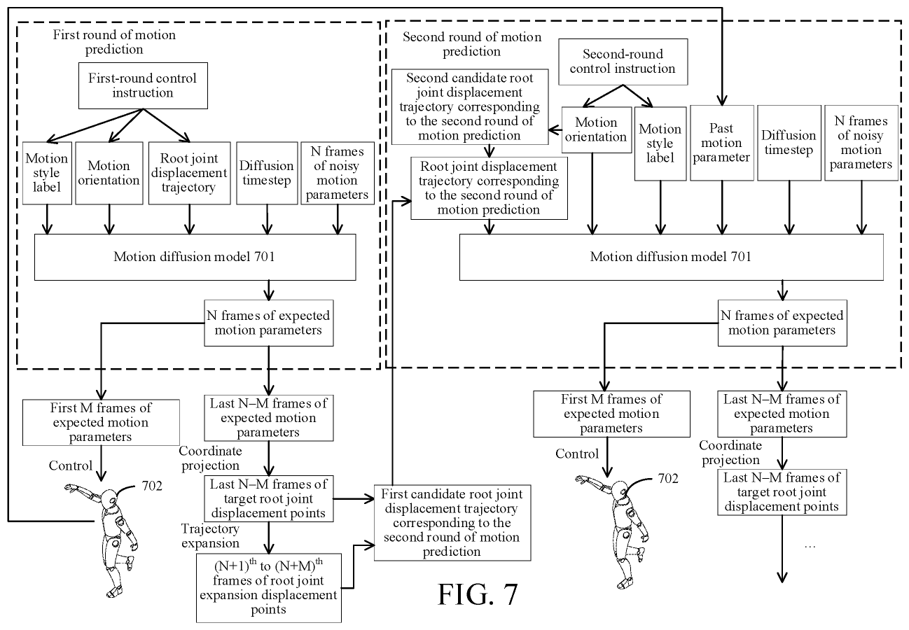

With reference to each of the foregoing embodiments, FIG. 7 is a flowchart of controlling a controlled object based on expected motion parameters for a plurality of rounds of motion prediction according to an embodiment of this disclosure.

During the first round of motion prediction, the computer device determines a motion style label, a motion orientation, and a root joint displacement trajectory based on a first-round control instruction, obtains N frames of noisy motion parameters by sampling Gaussian noise, and inputs the motion style label, the motion orientation, the root joint displacement trajectory, a diffusion timestep, and the N frames of noisy motion parameters into a motion diffusion model 701, to obtain N frames of expected motion parameters output by the motion diffusion model 701. Further, the computer device controls a controlled object 702 by using first M frames of expected motion parameters, and uses last N−M frames of expected motion parameters for trajectory expansion.

For a trajectory expansion process, the computer device projects target root joint coordinates in the last N−M frames of expected motion parameters to a horizontal coordinate plane, to obtain last N−M frames of target root joint displacement points, obtains (N+1)^{th} to (N+M)^{th} frames of root joint expansion displacement points through trajectory expansion based on the last N−M frames of target root joint displacement points, and generates, based on the last N−M frames of target root joint displacement points and the (N+1)^{th} to (N+M)^{th} frames of root joint expansion displacement points, a first candidate root joint displacement trajectory corresponding to the second round of motion prediction.

When receiving a second-round control instruction, the computer device first determines a motion orientation and a motion style label based on the second-round control instruction, generates a second candidate root joint displacement trajectory based on the motion orientation, and obtains, through trajectory fusion based on the first candidate root joint displacement trajectory and the second candidate root joint displacement trajectory, a root joint displacement trajectory corresponding to the second round of motion prediction. In addition, the computer device determines a set of past motion parameters based on a motion performed by the controlled object 702 in the first round, and inputs the set of past motion parameters, the root joint displacement trajectory, the motion orientation, the motion style label, the diffusion timestep, and the N frames of noisy motion parameters into the motion diffusion model 701, to obtain N frames of expected motion parameters output by the motion diffusion model 701.

In some embodiments, to improve motion prediction quality of the motion diffusion model, before performing motion prediction by using the motion diffusion model, the computer device further needs to first train the motion diffusion model by using a large quantity of motion parameter ground truths.

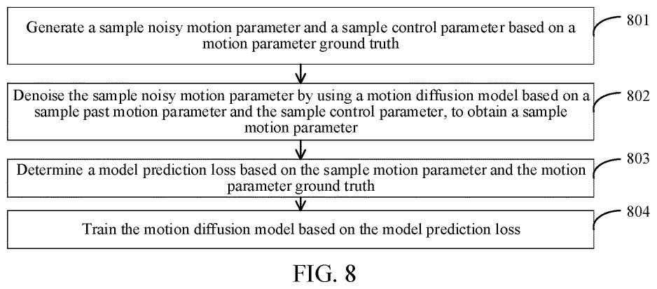

FIG. 8 is a flowchart of a training method for a motion diffusion model according to an embodiment of this disclosure. An example in which the method is applied to the computer device (including the terminal and/or the server) is used for description in this embodiment. The method includes the following operations.
Operation 801: Generate a set of sample noisy motion parameters and a set of sample control parameters based on a motion parameter ground truth.

The sample control parameter is generated based on the motion parameter ground truth, is usable for training the motion diffusion model, includes a sample motion style label, a sample root joint displacement trajectory, a sample motion orientation, and the like, and may be determined based on different frames of the motion parameter ground truth.

Before model training, the computer device first needs to generate the set of sample noisy motion parameters and the set of sample control parameters through data preprocessing based on the motion parameter ground truth.

In some embodiments, a single motion parameter ground truth dataset includes S frames of sample root joint coordinates and S frames of sample joint rotation parameters. In a possible implementation, the computer device may use first T frames of the motion parameter ground truth dataset as a model input, that is, perform noise adding on the first T frames of the motion parameter ground truth dataset to obtain the set of sample noisy motion parameters; and use last S-T frames of the motion parameter ground truth dataset for model training loss calculation, that is, determine the set of sample control parameters based on the last S-T frames of sample root joint coordinates and the last S-T frames of sample joint rotation parameters.

For example, if a single motion parameter ground truth dataset includes 45 frames of sample root joint coordinates and 45 frames of sample joint rotation parameters, the computer device may perform noise adding on the 1^{st} to 10^{th} frames of the motion parameter ground truth dataset to obtain the set of sample noisy motion parameters, and use the 11^{th} to 45^{th} frames of the motion parameter ground truth dataset for model training loss calculation.

In some embodiments, the set of sample control parameters includes the sample motion style label, the sample root joint displacement trajectory, and the sample motion orientation. The sample motion style label may be determined based on a motion style represented by each frame of the motion parameter ground truth. The sample root joint displacement may be determined based on each frame of root joint coordinates of the motion parameter ground truth value. The sample motion orientation may be determined based on a projected motion orientation of the controlled object between consecutive frames.
Operation 802: Denoise the set of sample noisy motion parameters by using the motion diffusion model based on a set of sample past motion parameters and the set of sample control parameters, to obtain a set of sample motion parameters.

In some embodiments, after generating the set of sample noisy motion parameters and the set of sample control parameters, the computer device may denoise the set of sample noisy motion parameters by using the motion diffusion model based on the set of sample past motion parameters and the set of sample control parameters, to obtain the set of sample motion parameters.

The set of sample motion parameters is a motion parameter obtained by the motion diffusion model by denoising the set of sample noisy motion parameters based on the set of sample past motion parameters and the set of sample control parameters, and is used for comparison with the motion parameter ground truth dataset for determining a model prediction loss, to train the motion diffusion model. In a denoising process, a denoising result obtained by using a single diffusion timestep may also be used as a set of sample motion parameters for a motion prediction.

The set of sample past motion parameters is used in a training process of the motion diffusion model, is used as a model input together with the set of sample control parameters to denoise the set of sample noisy motion parameters to obtain the set of sample motion parameters, and may be set to zero based on a parameter zero-setting probability during model training.

In a possible implementation, in a process of denoising the set of sample noisy motion parameters by using the motion diffusion model, the computer device may further use a denoising result obtained by using a single diffusion timestep as a set of sample motion parameters for a motion prediction.

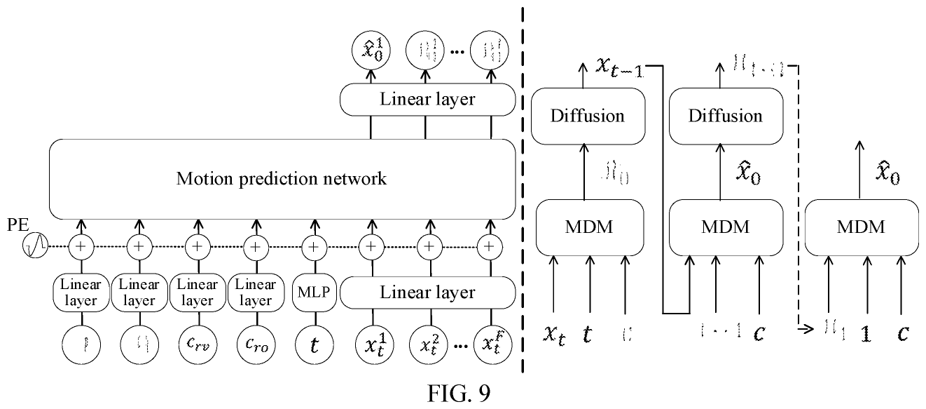

For example, as shown in FIG. 9, in a process of denoising the set of sample noisy motion parameters based on the diffusion timestep t, the motion diffusion model can obtain one sample motion parameter \hat{x}₀ each time the motion diffusion model denoises the set of sample noisy motion parameters xₜ, obtain a set of sample noisy motion parameters xₜ₋₁ each time the motion diffusion model diffuses the set of sample noisy motion parameters xₜ, and then obtain one sample motion parameter \hat{x}₀ and one sample noisy motion parameter xₜ₋₂ by performing denoising and diffusion once. Therefore, the computer device can train the motion diffusion model based on the set of sample motion parameters obtained through a single instance of denoising. This improves model training efficiency.

In some embodiments, considering that in the model training process, each motion parameter ground truth dataset may include a single motion style label, that is, there may be no motion style switching in the model training process, to reduce influence of the set of sample past motion parameters on a model output in the model training process, the computer device may set the parameter zero-setting probability, and set the set of sample past motion parameters to zero by using the parameter zero-setting probability. Therefore, the motion diffusion model can output accurate motion parameters even when there is no set of past motion parameters.

In some embodiments, the parameter zero-setting probability may be preset, or may be determined based on a model training situation. For example, the parameter zero-setting probability is 15%. The parameter zero-setting probability may be preset, and is usually valued from 0 to 1, for example, is set to 15%. Alternatively, the parameter zero-setting probability may be dynamically determined based on the model training situation. For example, a high parameter zero-setting probability is set in an early stage of model training, enabling the model to learn a motion feature with less dependence on the set of past motion parameters. As training progresses, the parameter zero-setting probability is gradually reduced, allowing the model to learn by referring more to the set of past motion parameters.

In a possible implementation, in the model training process, the computer device sets the set of sample past motion parameters to zero based on the parameter zero-setting probability. Further, when the set of sample past motion parameters is not set to zero, the computer device denoises the set of sample noisy motion parameters by using the motion diffusion model based on the set of sample past motion parameters and the set of sample control parameters, to obtain the set of sample motion parameters. When the set of sample past motion parameters is set to zero, the computer device denoises the set of sample noisy motion parameters by using the motion diffusion model based on the set of sample control parameters, to obtain the set of sample motion parameters.
Operation 803: Determine the model prediction loss based on the set of sample motion parameters and the motion parameter ground truth.

After obtaining the set of sample motion parameters outputted by the motion diffusion model, the computer device may determine the model prediction loss based on the set of sample motion parameters and the motion parameter ground truth.

The model prediction loss is determined based on the set of sample motion parameters and the motion parameter ground truth, is used for training the motion diffusion model, and may be determined based on at least one of a motion prediction loss, a speed loss, a joint position loss, a foot contact loss, or the like. Corresponding loss weights may be set for different losses.

In a possible implementation, to improve the motion prediction accuracy, the computer device may calculate the motion prediction loss by using a mean square error loss based on the set of sample motion parameters and the motion parameter ground truth. The motion prediction loss is a component of the model prediction loss, is calculated by using the mean square error loss based on the set of sample motion parameters and the motion parameter ground truth, and is used for measuring the motion prediction accuracy.

In some embodiments, the set of sample motion parameters may be represented as \hat{x}₀, the motion parameter ground truth dataset may be represented as x₀, and the motion prediction loss may be represented as

$${L}_{sample} = E {‖ {\hat{x}}_{0} - {x}_{0} ‖}_{2}^{2} .$$

In another possible implementation, to improve smoothness between motions, the computer device may further calculate the speed loss by using the mean square error loss based on a sample motion parameter difference between adjacent frames in the set of sample motion parameters and a ground truth motion parameter difference between adjacent frames in the motion parameter ground truth.

In some embodiments, the sample motion parameter difference between adjacent frames in the set of sample motion parameters may be represented as

$${\hat{x}}_{0}^{i + 1} - {\hat{x}}_{0}^{i} ,$$

the ground truth motion parameter difference between adjacent frames in the motion parameter ground truth dataset may be represented as

$${x}_{0}^{i + 1} - {x}_{0}^{i} ,$$

and the speed ross may be represented as

$${L}_{vel} = E {‖ ( {\hat{x}}_{0}^{i + 1} - {\hat{x}}_{0}^{i} ) - ( {x}_{0}^{i + 1} - {x}_{0}^{i} ) ‖}_{2}^{2} .$$

In another possible implementation, to improve accuracy of predicting each joint position, the computer device may first determine a sample joint position and a joint position ground truth by using a forward kinematics function based on the set of sample motion parameters and the motion parameter ground truth, and calculates the joint position loss by using the mean square error loss based on the sample joint position and the joint position ground truth. The forward kinematics function is used in a loss determining process of model training. The sample joint position and the joint position ground truth may be determined by using the function based on the set of sample motion parameters and the motion parameter ground truth, to subsequently calculate the joint position loss.

In some embodiments, the sample joint position may be represented as FK(\hat{x}₀, S), and the joint position ground truth may be represented as FK(x₀, S), where S is a static skeleton used in training data, and S remains unchanged in the training process.

In some embodiments, the joint position loss may be represented as

$${L}_{pos} = E {‖ F K ( {\hat{x}}_{0} , S ) - F K ( {x}_{0} , S ) ‖}_{2}^{2} .$$

In another possible implementation, to improve authenticity of motion prediction, the computer device may further calculate the foot contact loss by using the mean square error loss based on foot contact data in the joint position ground truth and a sample foot joint displacement difference between adjacent frames in the sample joint position.

In some embodiments, the sample foot joint displacement difference between adjacent frames in the sample joint position may be represented as

$$F K ( {\hat{x}}_{0}^{i + 1} ) - F K ( {\hat{x}}_{0}^{i} ) ,$$

and the foot contact loss may be represented as

$${L}_{foot} = E {‖ ( F K ( {\hat{x}}_{0}^{i + 1} ) - F K ( {\hat{x}}_{0}^{i} ) ) \cdot {f}_{i} ‖}_{2}^{2} ,$$

where fᵢ is a binary foot contact mask, is used when the foot contact loss is calculated, and is represented as fᵢ. A value range of fᵢ is {0,1}. fᵢ=0 indicates that the foot is not in contact with the ground. fᵢ=1 indicates that the foot is in contact with the ground.

Further, after determining various losses, the computer device may determine the model prediction loss based on at least one of the motion prediction loss, the speed loss, the joint position loss, or the foot contact loss.

In a possible implementation, the computer device sets corresponding loss weights for different losses based on importance of different losses for model training, and determines the model prediction loss based on the motion prediction loss, a first loss weight corresponding to the motion prediction loss, the speed loss, a second loss weight corresponding to the speed loss, the joint position loss, a third loss weight corresponding to the joint position loss, the foot contact loss, and a fourth loss weight corresponding to the foot contact loss.

In some embodiments, the model prediction loss may be represented as L=λₛₐₘₚₗₑLₛₐₘₚₗₑ+λ_{foot}L_{foot}+λₚₒₛLₚₒₛ+λᵥₑₗLᵥₑₗ. Loss weights corresponding to different losses may be the same or different. In a possible implementation, λₛₐₘₚₗₑ=λ_{foot}=λₚₒₛ=λᵥₑₗ=1.
Operation 804: Train the motion diffusion model based on the model prediction loss.

In some embodiments, after determining the model prediction loss, the computer device may train the motion diffusion model based on the model prediction loss, and update a model parameter of the motion diffusion model, to continue to perform sample motion prediction by using the updated motion diffusion model, until the model prediction loss is minimum.

In the foregoing embodiment, in the process of training the motion diffusion model, losses in different dimensions, including the motion prediction loss, the speed loss, the joint position loss, and the foot contact loss, may be determined based on different training targets, then the model training loss is determined based on different losses and corresponding loss weights, and the motion diffusion model is trained by using the model training loss, that is, the motion diffusion model may be optimized, to improve motion prediction accuracy of the motion diffusion model.

In some embodiments, the object control method provided in one or more embodiments of this disclosure may be applied to a plurality of scenarios, for example, a game interaction scenario and a robot control scenario.

### For the Game Interaction Scenario

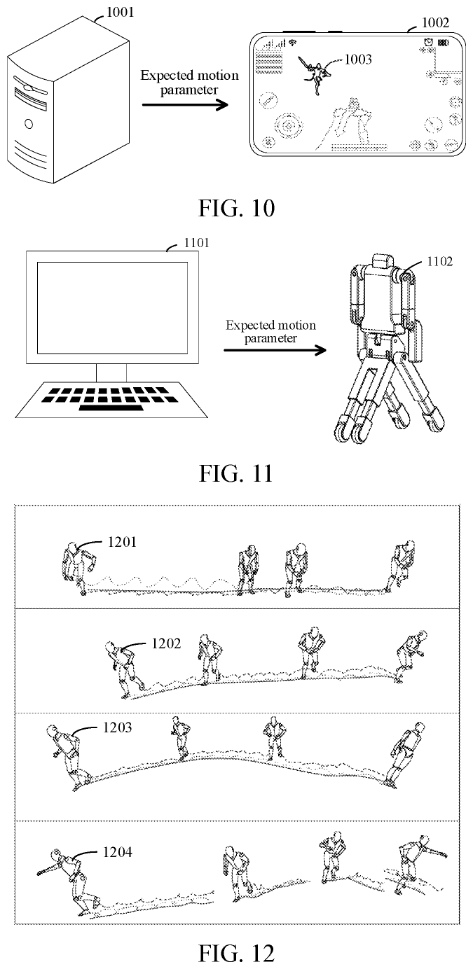

An example in which the object control method provided in one or more embodiments of this disclosure is applied to the game interaction scenario is used for description. FIG. 10 is a schematic diagram of application of an object control method to a game interaction scenario according to an embodiment of this disclosure. As shown in FIG. 10, in the game interaction scenario, a terminal 1002 receives a control instruction input by a player, and determines a set of control parameters based on the control instruction. Further, the terminal 1002 transmits the set of control parameters and a set of past motion parameters to a server 1001. In some aspects, the server 1001 may be a computer device. The server 1001 denoises, by using a motion diffusion model based on the set of control parameters and the set of past motion parameters, a set of noisy motion parameters sampled from Gaussian noise, to obtain a set of expected motion parameters for a current motion prediction round, and returns the set of expected motion parameters to the terminal 1002. The terminal 1002 controls a virtual object 1003 in a game scene based on the set of expected motion parameters.

In some embodiments, the set of control parameters for the virtual object 1003 may include a motion style label, a root joint displacement trajectory, and a motion orientation. The motion style label may indicate a motion style of the virtual object 1003. The root joint displacement trajectory may indicate a movement trajectory of the virtual object 1003. The motion orientation may indicate a movement orientation of the virtual object 1003.

In a possible implementation, the server 1001 respectively encodes the set of past motion parameters, the motion style label, the root joint displacement trajectory, and the motion orientation by using a feature mapping layer of the motion diffusion model, to obtain a past motion feature, a motion style feature, a root joint displacement feature, and a motion orientation feature. The motion diffusion model includes a plurality of feature mapping layers, and the set of past motion parameters, the motion style label, the root joint displacement trajectory, and the motion orientation respectively correspond to different feature mapping layers.

In a possible implementation, when the motion style label for the current motion prediction round is consistent with a motion style label for a previous motion prediction round, the server 1001 denoises, by using the motion diffusion model based on the past motion feature, the motion style feature, the root joint displacement feature, and the motion orientation feature, the set of noisy motion parameters sampled from the Gaussian noise, to obtain the set of expected motion parameters for the current motion prediction round.

In another possible implementation, when the motion style label for the current motion prediction round is inconsistent with a motion style label for a previous motion prediction round, the server 1001 may first denoise, by using the motion diffusion model based on the past motion feature, the motion style feature, the root joint displacement feature, and the motion orientation feature, the set of noisy motion parameters sampled from the Gaussian noise, to obtain a first set of candidate motion parameters, then denoise, by using the motion diffusion model based on the motion style feature, the root joint displacement feature, and the motion orientation feature, the set of noisy motion parameters sampled from the Gaussian noise, to obtain a second set of candidate motion parameters, and finally fuse the first set of candidate motion parameters and the second set of candidate motion parameters to obtain the set of expected motion parameters for the current motion prediction round.

Regarding a process of fusing the first set of candidate motion parameters and the second set of candidate motion parameters, in a possible implementation, the server 1001 determines a motion parameter difference based on the first set of candidate motion parameters and the second set of candidate motion parameters, determines a motion style guidance of the motion style label for the current motion prediction round based on the motion parameter difference and a guidance ratio, and determines the set of expected motion parameters for the current motion prediction round based on the second set of candidate motion parameters and the motion style guidance.

In some embodiments, the set of expected motion parameters includes N frames of target root joint coordinates and N frames of joint rotation parameters, and the terminal 1002 may control the virtual object 1003 based on first M frames of target root joint coordinates and first M frames of joint rotation parameters in the set of expected motion parameters, M being less than N.

In a possible implementation, to determine a root joint displacement trajectory for a next motion prediction round, the server 1001 may project the N frames of target root joint coordinates to a coordinate plane to obtain a target root joint displacement trajectory; determine, in last N−M frames of target root joint displacement points, symmetry points of an (N−1)^{th} frame of target root joint displacement point to an (N−L)^{th} frame of target root joint displacement point by using an N^{th} frame of target root joint displacement point as a central symmetry point, to obtain (N+1)^{th} to (N+L)^{th} frames of root joint expansion displacement points, L being less than N−M, thereby generating a root joint expansion trajectory based on the (N+1)^{th} to (N+L)^{th} frames of root joint expansion displacement points; generate a first candidate root joint displacement trajectory for the next motion prediction round based on the last N−M frames of target root joint displacement points and M frames of root joint expansion displacement points; generate a second candidate root joint displacement trajectory for the next motion prediction round based on a motion orientation for the next motion prediction round; and obtain the root joint displacement trajectory for the next motion prediction round through trajectory fusion based on the first candidate root joint displacement trajectory and the second candidate root joint displacement trajectory.

### For the Robot Control Scenario

An example in which the object control method provided in one or more embodiments of this disclosure is applied to the robot control scenario is used for description. FIG. 11 is a schematic diagram of application of an object control method to a robot control scenario according to an embodiment of this disclosure. As shown in FIG. 11, in the robot control scenario, a terminal 1101 obtains, in response to a control instruction, a set of control parameters from the control instruction, denoises, by using a motion diffusion model based on the set of control parameters and a set of past motion parameters of a robot 1102, a set of noisy motion parameters sampled from Gaussian noise, to obtain a set of expected motion parameters for a current motion prediction round, and controls the robot 1102 based on the set of expected motion parameters. In some aspects, the terminal 1101 may be a computer device.

In some embodiments, the set of control parameters for the robot 1102 may include a motion style label, a root joint displacement trajectory, and a motion orientation. The motion style label may indicate a motion style of the robot 1102. The root joint displacement trajectory may indicate a movement trajectory of the robot 1102. The motion orientation may indicate a movement orientation of the robot 1102.

In a possible implementation, the terminal 1101 respectively encodes the set of past motion parameters, the motion style label, the root joint displacement trajectory, and the motion orientation by using a feature mapping layer of the motion diffusion model, to obtain a past motion feature, a motion style feature, a root joint displacement feature, and a motion orientation feature. The motion diffusion model includes a plurality of feature mapping layers, and the set of past motion parameters, the motion style label, the root joint displacement trajectory, and the motion orientation respectively correspond to different feature mapping layers.

In a possible implementation, when the motion style label for the current motion prediction round is consistent with a motion style label for a previous motion prediction round, the terminal 1101 denoises, by using the motion diffusion model based on the past motion feature, the motion style feature, the root joint displacement feature, and the motion orientation feature, the set of noisy motion parameters sampled from the Gaussian noise, to obtain the set of expected motion parameters for the current motion prediction round.

In another possible implementation, when the motion style label for the current motion prediction round is inconsistent with a motion style label for a previous motion prediction round, the terminal 1101 may first denoise, by using the motion diffusion model based on the past motion feature, the motion style feature, the root joint displacement feature, and the motion orientation feature, the set of noisy motion parameters sampled from the Gaussian noise, to obtain a first set of candidate motion parameters, then denoise, by using the motion diffusion model based on the motion style feature, the root joint displacement feature, and the motion orientation feature, the set of noisy motion parameters sampled from the Gaussian noise, to obtain a second set of candidate motion parameters, and finally fuse the first set of candidate motion parameters and the second set of candidate motion parameters to obtain the set of expected motion parameters for the current motion prediction round.

Regarding a process of fusing the first set of candidate motion parameters and the second set of candidate motion parameters, in a possible implementation, the terminal 1101 determines a motion parameter difference based on the first set of candidate motion parameters and the second set of candidate motion parameters, determines a motion style guidance of the motion style label for the current motion prediction round based on the motion parameter difference and a guidance ratio, and determines the set of expected motion parameters for the current motion prediction round based on the second set of candidate motion parameters and the motion style guidance.

In some embodiments, the set of expected motion parameters includes N frames of target root joint coordinates and N frames of joint rotation parameters, and the terminal 1001 may control the robot 1102 based on first M frames of target root joint coordinates and first M frames of joint rotation parameters in the set of expected motion parameters, M being less than N.

In a possible implementation, to determine a root joint displacement trajectory for a next motion prediction round, the terminal 1101 may project the N frames of target root joint coordinates to a coordinate plane to obtain a target root joint displacement trajectory; determine, in last N−M frames of target root joint displacement points, symmetry points of an (N−1)^{th} frame of target root joint displacement point to an (N−L)^{th} frame of target root joint displacement point by using an N^{th} frame of target root joint displacement point as a central symmetry point, to obtain (N+1)^{th} to (N+L)^{th} frames of root joint expansion displacement points, L being less than N−M, thereby generating a root joint expansion trajectory based on the (N+1)^{th} to (N+L)^{th} frames of root joint expansion displacement points; generate a first candidate root joint displacement trajectory for the next motion prediction round based on the last N−M frames of target root joint displacement points and M frames of root joint expansion displacement points; generate a second candidate root joint displacement trajectory for the next motion prediction round based on a motion orientation for the next motion prediction round; and obtain the root joint displacement trajectory for the next motion prediction round through trajectory fusion based on the first candidate root joint displacement trajectory and the second candidate root joint displacement trajectory.

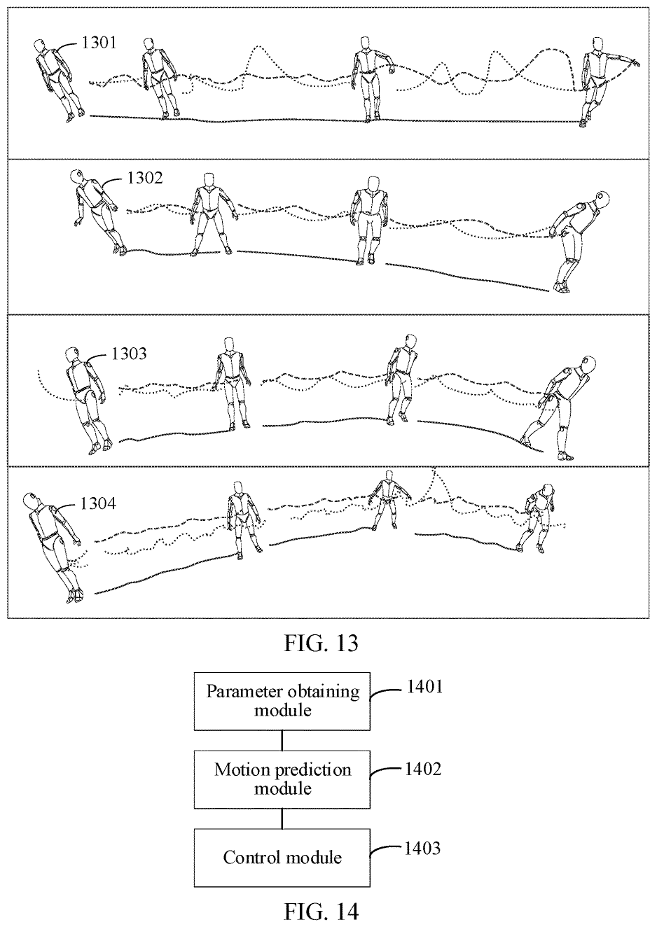

With reference to the foregoing embodiments, the object control method provided in one or more embodiments of this disclosure may provide the following technical effects.
1. According to the object control method provided in one or more embodiments of this disclosure, the motion prediction process is implemented based on the motion diffusion model, and after model training is completed, diverse high-quality motions can be generated at a speed of 60 fps, improving practicality of the method.
2. In one or more embodiments of this disclosure, diverse motion prediction styles and smooth transition between motions in a case of switching between different styles can be achieved with reference to the motion sampling principle of classifier-free guidance. For example, FIG. 12 is a diagram of comparison between effects of the object control method provided in this disclosure and a related technology when the motion style is switched from “jumping on the right foot” to “jumping on the left foot”. A controlled object 1201 corresponding to this disclosure can sequentially complete switching from jumping on the right foot to jumping on the left foot, while a controlled object 1202 based on a local motion phase (LMP), a controlled object 1203 based on a memory augmented neural network-deep phase (MANN-PP), and a controlled object 1204 based on a motion matching-deep phase (MM-PP) may not successfully complete switching from jumping on the right foot to jumping on the left foot.
3. In one or more embodiments of this disclosure, implementing motion prediction by using the motion diffusion model can also implement diverse motions in a single style. For example, as shown in FIG. 13, an example in which the motion style is a drunken and dizzy state and the motion orientation is rightward is used. In a process in which a controlled object 1301 corresponding to this disclosure moves rightward, a root node moves stably, and left-right hand motion transition effects are good. In a process in which a controlled object 1302 based on an LMP, a controlled object 1303 based on an MANN-DP, and a controlled object 1304 based on an MM-DP move rightward, movement curves of root nodes are large, and left-right hand motion transition effects are poor.
4. According to the object control method provided by one or more embodiments of this disclosure, high control quality and more diverse motion styles can be achieved.

For example, Table 1 shows a quantitative result of a single-style character control experiment made by using the object control method provided in one or more embodiments of this disclosure. As shown in Table 1, motion quality and a condition alignment in the object control method are good. Indicators for measuring the motion quality may include a distance (Fréchet inception distance, FID) between a generated motion distribution and a training distribution, a foot sliding distance (Ft.Slid), and an acceleration (Accel). Indicators for measuring the condition alignment may include a trajectory error (Traj.Err), an orientation error (Orient.Err), and a style acceleration (Styl.Acc). The FID is one of the indicators for measuring the motion quality, and represents the distance between the generated motion distribution and the training distribution. A smaller value indicates better motion quality. The Ft. Slid is one of the indicators for measuring the motion quality, and indicates a foot sliding distance. A smaller value indicates better motion quality. The Accel is one of the indicators for measuring the motion quality, and represents motion smoothness. A smaller value indicates better motion smoothness and better motion quality. The Traj. Err is one of the indicators for measuring the condition alignment, and indicates a trajectory error. A smaller value indicates a better condition alignment. The Orient. Err is one of the indicators for measuring the condition alignment, and indicates an orientation error. A smaller value indicates a better condition alignment. The Styl. Acc is one of the indicators for measuring the condition alignment, and indicates a style generation rate. A larger value indicates a better condition alignment.

TABLE 1

| | | | | Condition alignment | | |
|---|---|---|---|---|---|---|
| | Motion quality | | | | Orient. Err. | |
| | FID↓ | Ft. Slid. ↓ | Accel. ↓ | Traj. Err. ↓ | ↓ | Styl. Acc. ↑ |
| MM-DP | 1.374 | 0.023 | 1.465 | 33.125 | 20.679 | 60.8% |
| LMP | 4.021 | 0.043 | 3.055 | 9.601 | 8.036 | 87.0% |
| MANN-DP | 4.099 | 0.038 | 2.182 | 12.591 | 11.787 | 82.1% |
| This solution | 1.306 | 0.034 | 1.403 | 7.978 | 8.246 | 97.8% |

For example, Table 2 shows a quantitative result of a multi-style transition experiment made by using the object control method provided in one or more embodiments of this disclosure. As shown in Table 2, according to the object control method, a transition to a new target style is implemented reliably and efficiently in the multi-style transition experiment, with a few transition frames required and a very high success rate. Indicators for measuring a style transition may include a transition duration (Trans.Dura) and a transition success rate (Succ.Rate). The Trans. Dura is one of the indicators for measuring the style transition, and indicates a quantity of frames required for the style transition. A smaller value indicates a more efficient style transition. The Succ. Rate is one of the indicators for measuring the style transition, and indicates a success rate of the style transition. A larger value indicates a more reliable style transition.

TABLE 2

| | Motion quality | | | Style transition | |
|---|---|---|---|---|---|
| | FID↓ | Ft.Slid.↓ | Accel.↓ | Trans.Dura.↓ | Succ.Rate ↑ |
| MM-DP | 1.429 | 0.030 | 1.360 | 69.34 | 56.0% |
| LMP | 2.224 | 0.059 | 3.169 | 72.22 | 75.6% |
| MANN-DP | 2.643 | 0.044 | 2.921 | 82.86 | 62.4% |
| This solution | 1.065 | 0.043 | 1.608 | 48.47 | 94.2% |

FIG. 14 is a block diagram of a structure of an object control apparatus according to an embodiment of this disclosure. The apparatus includes:
a parameter obtaining module 1401, configured to obtain a set of past motion parameters and a set of control parameters, the set of past motion parameters representing a past motion performed by a controlled object before a current motion prediction round, and the set of control parameters representing a motion expectation for the controlled object in the current motion prediction round;
a motion prediction module 1402, configured to denoise, by using a motion diffusion model based on the set of past motion parameters and the set of control parameters, a set of noisy motion parameters sampled from Gaussian noise, to obtain a set of expected motion parameters for the current motion prediction round; and
a control module 1403, configured to control the controlled object based on the set of expected motion parameters.

In some embodiments, the set of control parameters includes a motion style label, a root joint displacement trajectory, and a motion orientation. The motion style label may indicate a motion style of the controlled object. The root joint displacement trajectory may indicate a movement trajectory of the controlled object. The motion orientation may indicate a movement orientation of the controlled object.

The motion prediction module 1402 includes:
a feature encoding unit, configured to encode, by using a feature mapping layer of the motion diffusion model, the set of past motion parameters to obtain a past motion feature, encode the motion style label to obtain a motion style feature, encode the root joint displacement trajectory to obtain a root joint displacement feature, and encode the motion orientation to obtain a motion orientation feature; and
a motion prediction unit, configured to denoise the set of noisy motion parameters by using the motion diffusion model based on the past motion feature, the motion style feature, the root joint displacement feature, and the motion orientation feature, to obtain the set of expected motion parameters for the current motion prediction round.

In some embodiments, the motion diffusion model includes a plurality of feature mapping layers, and the set of past motion parameters, the motion style label, the root joint displacement trajectory, and the motion orientation respectively correspond to different feature mapping layers.

In some embodiments, the motion prediction unit is configured to:
denoise, when the motion style label for the current motion prediction round is consistent with a motion style label for a previous motion prediction round, the set of noisy motion parameters by using the motion diffusion model based on the past motion feature, the motion style feature, the root joint displacement feature, and the motion orientation feature, to obtain the set of expected motion parameters for the current motion prediction round.

In some embodiments, the motion prediction unit is configured to:
denoise, when the motion style label for the current motion prediction round is inconsistent with the motion style label for the previous motion prediction round, the set of noisy motion parameters twice by using the motion diffusion model based on the past motion feature, the motion style feature, the root joint displacement feature, and the motion orientation feature, to obtain two denoising results, the past motion feature being set to zero in one denoising process; and
determine the set of expected motion parameters for the current motion prediction round based on the two denoising results.

In some embodiments, the motion prediction unit is configured to:
denoise the set of noisy motion parameters by using the motion diffusion model based on the past motion feature, the motion style feature, the root joint displacement feature, and the motion orientation feature, to obtain a first set of candidate motion parameters; and
denoise the set of noisy motion parameters by using the motion diffusion model based on the motion style feature, the root joint displacement feature, and the motion orientation feature, to obtain a second set of candidate motion parameters.

The motion prediction unit is further configured to:
fuse the first set of candidate motion parameters and the second set of candidate motion parameters to obtain the set of expected motion parameters for the current motion prediction round.

In some embodiments, the motion prediction unit is further configured to:
determine a motion parameter difference based on the first set of candidate motion parameters and the second set of candidate motion parameters;
determine a motion style guidance of the motion style label for the current motion prediction round based on the motion parameter difference and a guidance ratio, the guidance ratio being used to adjust a degree of influence of the first set of candidate motion parameters on the set of expected motion parameters, and the motion style guidance being the influence of the first set of candidate motion parameters on the set of expected motion parameters; and
determine the set of expected motion parameters for the current motion prediction round based on the second set of candidate motion parameters and the motion style guidance.

In some embodiments, the set of expected motion parameters includes target root joint coordinates for N frames and N frames of joint rotation parameters.

The control module 1403 is configured to:
control the controlled object based on first M frames of target root joint coordinates and first M frames of joint rotation parameters in the set of expected motion parameters, M being less than N.

The apparatus further includes:
a coordinate projection module, configured to project the N frames of target root joint coordinates to a coordinate plane to obtain a target root joint displacement trajectory;
a trajectory expansion module, configured to obtain a root joint expansion trajectory through trajectory expansion based on last N−M frames of target root joint displacement points in the target root joint displacement trajectory, the root joint expansion trajectory including M frames of root joint expansion displacement points; and
a trajectory determining module, configured to determine a root joint displacement trajectory for a next motion prediction round based on the last N−M frames of target root joint displacement points and the M frames of root joint expansion displacement points.

In some embodiments, the trajectory expansion module is configured to:
determine, in the last N−M frames of target root joint displacement points, symmetry points of an (N−1)^{th} frame of target root joint displacement point to an (N−L)^{th} frame of target root joint displacement point by using an N^{th} frame of target root joint displacement point as a central symmetry point, to obtain (N+1)^{th} to (N+L)^{th} frames of root joint expansion displacement points, L being less than N−M; and
generate the root joint expansion trajectory based on the (N+1)^{th} to (N+L)^{th} frames of root joint expansion displacement points.

In some embodiments, the trajectory determining module is configured to:
generate a first candidate root joint displacement trajectory for the next motion prediction round based on the last N−M frames of target root joint displacement points and the M frames of root joint expansion displacement points;
generate a second candidate root joint displacement trajectory for the next motion prediction round based on a motion orientation for the next motion prediction round; and
obtain the root joint displacement trajectory for the next motion prediction round through trajectory fusion based on the first candidate root joint displacement trajectory and the second candidate root joint displacement trajectory.

In some embodiments, the apparatus further includes:
a sample generation module, configured to generate a set of sample noisy motion parameters and a set of sample control parameters based on a motion parameter ground truth;
a sample motion prediction module, configured to denoise the set of sample noisy motion parameters by using the motion diffusion model based on a set of sample past motion parameters and the set of sample control parameters, to obtain a set of sample motion parameters;
a loss determining module, configured to determine a model prediction loss based on the set of sample motion parameters and the motion parameter ground truth; and
a model training module, configured to train the motion diffusion model based on the model prediction loss.

In some embodiments, the loss determining module is configured to:
calculate a motion prediction loss by using a mean square error loss based on the set of sample motion parameters and the motion parameter ground truth;
calculate a speed loss by using the mean square error loss based on a sample motion parameter difference between adjacent frames in the set of sample motion parameters and a ground truth motion parameter difference between adjacent frames in the motion parameter ground truth;
determine a sample joint position and a joint position ground truth by using a forward kinematics function based on the set of sample motion parameters and the motion parameter ground truth;
calculate a joint position loss by using the mean square error loss based on the sample joint position and the joint position ground truth;
calculate a foot contact loss by using the mean square error loss based on foot contact data in the joint position ground truth and a sample foot joint displacement difference between adjacent frames in the sample joint position; and
determine the model prediction loss based on at least one of the motion prediction loss, the speed loss, the joint position loss, or the foot contact loss.

In some embodiments, the sample motion prediction module is configured to:
set the set of sample past motion parameters to zero based on a parameter zero-setting probability; and
denoise, when the set of sample past motion parameters is not set to zero, the set of sample noisy motion parameters by using the motion diffusion model based on the set of sample past motion parameters and the set of sample control parameters, to obtain the set of sample motion parameters; or
denoise, when the set of sample past motion parameters is set to zero, the set of sample noisy motion parameters by using the motion diffusion model based on the set of sample control parameters, to obtain the set of sample motion parameters.

In this embodiment of this disclosure, in a process of predicting a motion parameter by using the motion diffusion model, one-time output of long-duration motion parameters is converted into output of short-duration motion parameters in a plurality of rounds. This shortens duration corresponding to a motion parameter that needs to be generated each time, so that a requirement on a quantity of model parameters of the motion diffusion model is reduced, reducing a requirement on a model deployment condition. Moreover, in addition to the set of control parameters, the set of past motion parameters is added as a diffusion condition, and during each round of motion prediction, reference is made to a past motion previously performed by the controlled object. This improves continuity between motions during staged output, and improves output quality of the long-duration motion parameters.

The apparatus provided in the foregoing embodiment is described only using division into the foregoing functional modules as an example. In an actual application, the foregoing functions may be allocated to and completed by different functional modules as required. In other words, an internal structure of the apparatus is divided into different functional modules to complete all or a part of the functions described above. In addition, the apparatus provided in the foregoing embodiment falls within a same concept as the method embodiment. In some aspects, the apparatus may be implemented in view of one or more method examples described in this disclosure. Details may be simplified or omitted and thus may not be described again.

The modules, submodules, and units described in the foregoing embodiments may be implemented by processing circuitry, software executed by a processor, or a combination thereof. Modules implemented by software may be stored in memory (e.g., a non-transitory computer-readable storage medium) and executed by a processor to perform the described functions. The relationship between software modules and hardware modules (e.g., processors and memory) may be configured based on system requirements and design considerations.

In this disclosure, before and during obtaining of relevant data of a user, a prompt interface or a pop-up window may be displayed, or voice prompt information may be outputted. The prompt interface, the pop-up window, or the voice prompt information notifies the user that the relevant data of the user is currently being collected. In this way, in this disclosure, after a confirmation operation of the user for the prompt interface or the pop-up window is obtained, relevant operations of obtaining the relevant data of the user start to be performed. Otherwise (in other words, when a confirmation operation of the user for the prompt interface or the pop-up window is not obtained), relevant operations of obtaining the relevant data of the user are ended, that is, the relevant data of the user is not obtained. In other words, information (including but not limited to user device information, user personal information, and the like, and operational data corresponding to the user), data (including but not limited to data for analysis, stored data, presented data, and the like), and signals involved in this disclosure are all authorized by the user or fully authorized by various parties, and collection, use, and processing of the relevant data need to comply with relevant laws, regulations, and standards of relevant regions.

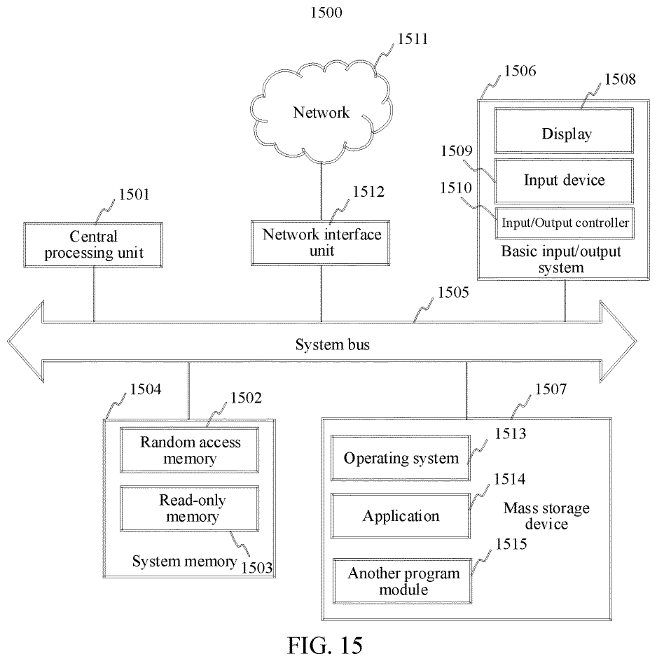

FIG. 15 is a schematic diagram of a structure of a computer device according to an embodiment of this disclosure. In some aspects, the computer device 1500 includes a central processing unit (CPU) 1501, a system memory 1504 including a random access memory 1502 and a read-only memory 1503, and a system bus 1505 connecting the system memory 1504 and the central processing unit 1501. The computer device 1500 may further include a basic input/output (I/O) system 1506 that facilitates transfer of information between elements within a computer, and a mass storage device 1507 configured to store an operating system 1513, an application 1514, and another program module 1515.

In some embodiments, the basic input/output system 1506 includes a display 1508 configured to display information and an input device 1509 configured to receive user input information, for example, a mouse or a keyboard. The display 1508 and the input device 1509 are both connected to the central processing unit 1501 by using an input/output controller 1510 connected to the system bus 1505. The basic input/output system 1506 may further include the input/output controller 1510 configured to receive and process inputs from a plurality of other devices such as the keyboard, the mouse, and an electronic stylus. Similarly, the input/output controller 1510 further provides an output to a display screen, a printer, or another type of output device.

The mass storage device 1507 is connected to the central processing unit 1501 by using a mass storage controller (not shown) connected to the system bus 1505. The mass storage device 1507 and a computer-readable medium associated with the mass storage device 1507 provide non-volatile storage for the computer device 1500. In other words, the mass storage device 1507 may include the computer-readable medium (not shown), such as a hard disk or a driver.

Without loss of generality, the computer-readable medium may include a computer storage medium and a communication medium. The computer storage medium includes volatile and nonvolatile media and removable and irremovable media that are implemented by any method or technology for storing information such as computer-readable instructions, a data structure, a program module, or other data. The computer storage medium includes a random access memory (RAM), a read-only memory (ROM), a flash memory or another solid-state storage technology, a compact disc read-only memory (CD-ROM), a digital versatile disc (DVD) or another optical storage, a magnetic cassette, a magnetic tape, a magnetic disk storage, or another magnetic storage device. A person skilled in the art may know that the computer storage medium is not limited to the foregoing several types. The system memory 1504 and the mass storage device 1507 may be collectively referred to as a memory.

The memory stores one or more programs. The one or more programs are configured to be executed by one or more central processing units 1501. The one or more programs include instructions for implementing the foregoing method. The central processing unit 1501 executes the one or more programs to implement the object control method provided in each of the foregoing method embodiments.

According to various embodiments of this disclosure, the computer device 1500 may further be connected, through a network such as the Internet, to a remote computer on the network for running. In other words, the computer device 1500 may be connected to a network 1511 by using a network interface unit 1512 connected to the system bus 1505, or may be connected to another type of network or a remote computer system (not shown) by using a network interface unit 1512.

An embodiment of this disclosure further provides a computer-readable storage medium. The readable storage medium has at least one instruction stored therein. The at least one instruction is loaded and executed by a processor, to implement the object control method described in the foregoing embodiment.

In some embodiments, the computer-readable storage medium may include a ROM, a RAM, a solid state drive (SSD), an optical disk, or the like. The RAM may include a resistance random access memory (ReRAM) and a dynamic random access memory (DRAM).

An embodiment of this disclosure provides a computer program product. The computer program product includes at least one instruction. The at least one instruction is stored in a computer-readable storage medium. A processor of a computer device reads the at least one instruction from the computer-readable storage medium. The processor executes the at least one instruction to enable the computer device to perform the object control method described in the foregoing embodiment.

A person of ordinary skill in the art may understand that all or a part of the operations in the foregoing embodiments may be completed by hardware or by a program instructing related hardware. The program may be stored in a computer-readable storage medium. The storage medium may be a read-only memory, a magnetic disk, an optical disk, or the like.

According to solutions in one or more embodiments of this disclosure, the computer device obtains the set of past motion parameters representing the past motion performed by the controlled object before the current motion prediction round, and the set of control parameters representing the motion expectation for the controlled object in the current motion prediction round, then denoises, by using the motion diffusion model based on the two parameters, the set of noisy motion parameters sampled from the Gaussian noise, to obtain the set of expected motion parameters for the current motion prediction round, and finally controls the controlled object based on the set of expected motion parameters. In this solution, one-time output of long-duration motion parameters is converted into output of short-duration motion parameters in a plurality of rounds, reducing the requirements on the quantity of model parameters and the model deployment condition of the motion diffusion model. In addition, the set of past motion parameters is added as a diffusion condition, so that the continuity between motions during staged output is improved, and output quality of the long-duration motion parameters is improved.

When the set of control parameters includes the motion style label indicating the motion style of the controlled object, the root joint displacement trajectory indicating the movement trajectory, and the motion orientation indicating the movement orientation, the computer device first respectively encodes the set of past motion parameters, the motion style label, the root joint displacement trajectory, and the motion orientation by using the feature mapping layer of the motion diffusion model, to obtain the past motion feature, the motion style feature, the root joint displacement feature, and the motion orientation feature, and then denoises the set of noisy motion parameters by using the motion diffusion model based on these features, to obtain the set of expected motion parameters for the current motion prediction round. In this solution, the feature mapping layer is disposed in the motion diffusion model to independently encode different parameters. This avoids coupling between features or a feature imbalance, and improves effectiveness of each feature, thereby improving the motion prediction stability and accuracy.

The motion diffusion model includes a plurality of feature mapping layers, and the set of past motion parameters, the motion style label, the root joint displacement trajectory, and the motion orientation respectively correspond to different feature mapping layers. This further improves independence of encoding of the parameter features, avoids interference between the features more effectively, and improves the motion prediction stability and accuracy.

If the motion style label for the current motion prediction round is consistent with the motion style label for the previous motion prediction round, the computer device directly denoises the set of noisy motion parameters by using the motion diffusion model based on the past motion feature, the motion style feature, the root joint displacement feature, and the motion orientation feature, to obtain the set of expected motion parameters for the current motion prediction round. In this way, the continuity and stability of motion prediction are improved when the motion style does not change.

When the motion style label for the current motion prediction round is inconsistent with the motion style label for the previous motion prediction round, the computer device denoises the set of noisy motion parameters twice by using the motion diffusion model based on the past motion feature, the motion style feature, the root joint displacement feature, and the motion orientation feature, to obtain the two denoising results, the past motion feature being set to zero in one denoising process; and then determine the set of expected motion parameters for the current motion prediction round based on the two denoising results. This can reduce the influence of the set of past motion parameters on the current motion prediction result, make motion prediction closer to the motion style indicated by the current motion style label, and improve the motion prediction accuracy.

The two denoising processes are respectively denoising the set of noisy motion parameters by using the motion diffusion model based on the past motion feature, the motion style feature, the root joint displacement feature, and the motion orientation feature, to obtain the first set of candidate motion parameters, and denoising the set of noisy motion parameters by using the motion diffusion model based on the motion style feature, the root joint displacement feature, and the motion orientation feature, to obtain the second set of candidate motion parameters. Then, the first set of candidate motion parameters and the second set of candidate motion parameters are fused to obtain the set of expected motion parameters for the current motion prediction round. In this solution, determining the set of expected motion parameters is implemented through the two denoising processes and result fusion during motion style switching, and hence improving the motion prediction accuracy.

The process of fusing the first set of candidate motion parameters and the second set of candidate motion parameters to obtain the set of expected motion parameters for the current motion prediction round is: first determining the motion parameter difference based on the first set of candidate motion parameters and the second set of candidate motion parameters; then determining the motion style guidance of the motion style label for the current motion prediction round based on the motion parameter difference and the guidance ratio, the guidance ratio being used to adjust the degree of the influence of the first set of candidate motion parameters on the set of expected motion parameters, and the motion style guidance being the influence of the first set of candidate motion parameters on the set of expected motion parameters; and finally determining the set of expected motion parameters for the current motion prediction round based on the second set of candidate motion parameters and the motion style guidance. In this solution, a quantization process of determining the set of expected motion parameters during motion style switching is described in further detail, improving motion prediction accuracy and operability.

When the set of expected motion parameters includes the N frames of target root joint coordinates and the N frames of joint rotation parameters, the computer device controls the controlled object based on the first M frames of target root joint coordinates and the first M frames of joint rotation parameters in the set of expected motion parameters (M is less than N), then projects the N frames of target root joint coordinates to the coordinate plane to obtain the target root joint displacement trajectory, then obtains, through trajectory expansion based on the last N−M frames of target root joint displacement points in the target root joint displacement trajectory, the root joint expansion trajectory including the M frames of root joint expansion displacement points, and finally determines the root joint displacement trajectory for the next motion prediction round based on the last N−M frames of target root joint displacement points and the M frames of root joint expansion displacement points. In this solution, segmental use and trajectory processing of the set of expected motion parameters reduce the jitter in the motion execution process, and improve the continuity of the motions of the controlled object between two motion predictions.

The process of obtaining the root joint expansion trajectory through trajectory expansion based on the last N−M frames of target root joint displacement points in the target root joint displacement trajectory is: determining, in the last N−M frames of target root joint displacement points, the symmetry points of the (N−1)^{th} frame of target root joint displacement point to the (N−L)^{th} frame of target root joint displacement point by using the N^{th} frame of target root joint displacement point as the central symmetry point (L is less than N−M), to obtain the (N+1)^{th} to (N+L)^{th} frames of root joint expansion displacement points; and generating the root joint expansion trajectory based on these root joint expansion displacement points. In this solution, implementations of trajectory expansion is described in further detail as non-limiting examples, helping generate an appropriate root joint displacement trajectory for the next motion prediction round, and further improving the motion continuity.

The process of determining the root joint displacement trajectory for the next motion prediction round based on the last N−M frames of target root joint displacement points and the M frames of root joint expansion displacement points is: first generating the first candidate root joint displacement trajectory for the next motion prediction round based on the last N−M frames of target root joint displacement points and the M frames of root joint expansion displacement points; then, generating the second candidate root joint displacement trajectory for the next motion prediction round based on the motion orientation for the next motion prediction round; and finally, obtaining the root joint displacement trajectory for the next motion prediction round through trajectory fusion based on the first candidate root joint displacement trajectory and the second candidate root joint displacement trajectory. In this solution, a plurality of factors are comprehensively considered to determine the root joint displacement trajectory for the next motion prediction round, optimizing trajectory generation and improving the motion continuity and a control effect.

The computer device generates the set of sample noisy motion parameters and the set of sample control parameters based on the motion parameter ground truth, then denoises the set of sample noisy motion parameters by using the motion diffusion model based on the set of sample past motion parameters and the set of sample control parameters, to obtain the set of sample motion parameters, then determines the model prediction loss based on the set of sample motion parameters and the motion parameter ground truth, and finally trains the motion diffusion model based on the model prediction loss. In this solution, the motion diffusion model is trained, and losses in different dimensions are determined based on different training targets, and are used to train the model, to optimize the motion diffusion model, improving the motion prediction accuracy.

The process of determining the model prediction loss based on the set of sample motion parameters and the motion parameter ground truth dataset is: calculating the motion prediction loss by using the mean square error loss based on the set of sample motion parameters and the motion parameter ground truth; calculating the speed loss by using the mean square error loss based on the sample motion parameter difference between adjacent frames in the set of sample motion parameters and the ground truth motion parameter difference between adjacent frames in the motion parameter ground truth; determining the sample joint position and the joint position ground truth by using the forward kinematics function based on the set of sample motion parameters and the motion parameter ground truth; calculating the joint position loss by using the mean square error loss based on the sample joint position and the joint position ground truth; calculating the foot contact loss by using the mean square error loss based on the foot contact data in the joint position ground truth and the sample foot joint displacement difference between adjacent frames in the sample joint position; and finally determining the model prediction loss based on at least one of the motion prediction loss, the speed loss, the joint position loss, or the foot contact loss. In this solution, implementations of calculating each item of the model prediction loss is described in further detail as non-limiting examples, which may improve the motion prediction accuracy from a plurality of dimensions.

The process of denoising the set of sample noisy motion parameters by using the motion diffusion model based on the set of sample past motion parameters and the set of sample control parameters, to obtain the set of sample motion parameters is: setting the set of sample past motion parameters to zero based on the parameter zero-setting probability; and denoising, when the set of sample past motion parameters is not set to zero, the set of sample noisy motion parameters by using the motion diffusion model based on the set of sample past motion parameters and the set of sample control parameters, to obtain the set of sample motion parameters; or denoising, when the set of sample past motion parameters is set to zero, the set of sample noisy motion parameters by using the motion diffusion model based on the set of sample control parameters, to obtain the set of sample motion parameters. In this solution, the parameter zero-setting probability is set, so that the influence of the set of sample past motion parameters on the model output in the model training process is reduced, and the model can output accurate motion parameters in different cases.

The technical features in the foregoing embodiments may be combined in any manner. To make the description brief, not all possible combinations of the technical features in the foregoing embodiments are described. However, provided that the combinations of the technical features do not conflict with each other, the combinations are to be considered as falling within the scope recorded in this specification.

The foregoing embodiments merely illustrate several implementations of this disclosure, and the descriptions are not to be construed as a limitation on the scope of the present disclosure. For a person of ordinary skill in the art, several transformations and improvements can be made without departing from the idea of this disclosure. These transformations and improvements shall fall within the scope of this disclosure.

What is claimed is:

1. An object control method, the method comprising:
obtaining a set of past motion parameters and a set of control parameters, the set of past motion parameters being from a previous motion prediction round and representing a past motion performed by a controlled object before a current motion prediction round, and the set of control parameters representing a motion expectation and a movement trajectory prediction for the controlled object in the current motion prediction round;
generating, by processing circuitry, a set of noisy motion parameters based on sampling a Gaussian noise;
generating, by the processing circuitry, a set of expected motion parameters for the current motion prediction round through a motion diffusion model based on the set of noisy motion parameters, the set of past motion parameters, and the set of control parameters; and
controlling a current motion of the controlled object based on the set of expected motion parameters for the current motion prediction round.

2. The method according to claim 1, wherein
the set of control parameters includes a motion style label, a root joint displacement trajectory, and a motion orientation, the motion style label indicating a motion style of the controlled object, the root joint displacement trajectory indicating the movement trajectory prediction of the controlled object, and the motion orientation indicating a movement orientation of the controlled object; and
the generating the set of expected motion parameter for the current motion prediction round includes:
encoding, through a feature mapping layer of the motion diffusion model, the set of past motion parameters to obtain a past motion feature;
encoding the motion style label to obtain a motion style feature;
encoding the root joint displacement trajectory to obtain a root joint displacement feature;
encoding the motion orientation to obtain a motion orientation feature;
denoising the set of noisy motion parameters through the motion diffusion model based on the past motion feature, the motion style feature, the root joint displacement feature, and the motion orientation feature, to obtain a first set of denoised motion parameters; and
obtaining the set of expected motion parameters for the current motion prediction round based on the first set of denoised motion parameters.

3. The method according to claim 2, wherein
the motion diffusion model includes a plurality of feature mapping layers; and
the set of past motion parameters, the motion style label, the root joint displacement trajectory, and the motion orientation respectively correspond to different feature mapping layers of the plurality of feature mapping layers.

4. The method according to claim 2, wherein
the generating the set of expected motion parameters for the current motion prediction round includes:
determining whether the motion style label for the current motion prediction round is consistent with a previous motion style label for the previous motion prediction round; and
the obtaining the set of expected motion parameters for the current motion prediction round includes:
determining the first set of denoised motion parameters as the set of expected motion parameters for the current motion prediction round when the motion style label is determined as consistent with the previous motion style label.

5. The method according to claim 4, wherein
the generating the set of expected motion parameters for the current motion prediction round includes:
denoising the set of noisy motion parameters through the motion diffusion model based on the past motion feature being set to zero, the motion style feature, the root joint displacement feature, and the motion orientation feature, to obtain a second set of denoised motion parameters when the motion style label is determined as inconsistent with the previous motion style label; and
the obtaining the set of expected motion parameters for the current motion prediction round includes:
determining the set of expected motion parameters for the current motion prediction round based on the first set of denoised motion parameters and the second set of denoised motion parameters when the motion style label is determined as inconsistent with the previous motion style labels.

6. The method according to claim 5, wherein
the determining the set of expected motion parameters for the current motion prediction round based on the first set of denoised motion parameters and the second set of denoised motion parameters comprises:
fusing the first set of denoised motion parameters and the second set of denoised motion parameters to obtain the set of expected motion parameters for the current motion prediction round.

7. The method according to claim 6, wherein the fusing the first set of denoised motion parameters and the second set of denoised motion parameters to obtain the set of expected motion parameters for the current motion prediction round comprises:
determining a motion parameter difference based on the first set of denoised motion parameters and the second set of denoised motion parameters;
determining a motion style guidance for the current motion prediction round based on the motion parameter difference and a guidance ratio, the motion style guidance representing influence of the first set of denoised motion parameters on the set of expected motion parameters; and
determining the set of expected motion parameters for the current motion prediction round based on the second set of denoised motion parameters and the motion style guidance.

8. The method according to claim 2, wherein
the set of expected motion parameters includes N frames of target root joint coordinates and N frames of joint rotation parameters, N being a positive integer;
the controlling the controlled object based on the set of expected motion parameters includes:
controlling the current motion of the controlled object is based on first M frames of target root joint coordinates and first M frames of joint rotation parameters in the set of expected motion parameters, M being a positive integer less than N; and
the method further includes:
projecting the N frames of target root joint coordinates to N frames of target root joint displacement points in a coordinate plane to obtain a target root joint displacement trajectory;
obtaining a root joint expansion trajectory through trajectory expansion based on last N−M frames of target root joint displacement points in the target root joint displacement trajectory, the root joint expansion trajectory including M frames of root joint expansion displacement points; and
determining a root joint displacement trajectory for a next motion prediction round based on the last N−M frames of target root joint displacement points and the M frames of root joint expansion displacement points.

9. The method according to claim 8, wherein the obtaining the root joint expansion trajectory comprises:
determining, in the last N−M frames of target root joint displacement points, symmetry points of an (N−1)^{th} frame of target root joint displacement point to an (N−L)^{th} frame of target root joint displacement point by using an N^{th} frame of target root joint displacement point as a central symmetry point, to obtain (N+1)^{th} to (N+L)^{th} frames of root joint expansion displacement points, L being less than N−M; and
generating the root joint expansion trajectory based on the (N+1)^{th} to (N+L)^{th} frames of root joint expansion displacement points.

10. The method according to claim 8, wherein the determining the root joint displacement trajectory for the next motion prediction round comprises:
generating a first candidate root joint displacement trajectory for the next motion prediction round based on the last N−M frames of target root joint displacement points and the M frames of root joint expansion displacement points;
generating a second candidate root joint displacement trajectory for the next motion prediction round based on a motion orientation for the next motion prediction round; and
obtaining the root joint displacement trajectory for the next motion prediction round through trajectory fusion based on the first candidate root joint displacement trajectory and the second candidate root joint displacement trajectory.

11. The method according to claim 1, wherein the method further comprises:
generating a set of sample noisy motion parameters and a set of sample control parameters based on a motion parameter ground truth dataset;
denoising the set of sample noisy motion parameters through the motion diffusion model based on a set of sample past motion parameters and the set of sample control parameters, to obtain a set of sample motion parameters;
determining a model prediction loss based on the set of sample motion parameters and the motion parameter ground truth dataset; and
training the motion diffusion model based on the model prediction loss.

12. The method according to claim 11, wherein the determining the model prediction loss comprises:
calculating a motion prediction loss by using a mean square error loss based on the set of sample motion parameters and the motion parameter ground truth dataset;
calculating a speed loss by using the mean square error loss based on a sample motion parameter difference between adjacent frames in the set of sample motion parameters and a ground truth motion parameter difference between adjacent frames in the motion parameter ground truth dataset;
determining a sample joint position and a joint position ground truth by using a forward kinematics function based on the set of sample motion parameters and the motion parameter ground truth dataset;
calculating a joint position loss by using the mean square error loss based on the sample joint position and the joint position ground truth;
calculating a foot contact loss by using the mean square error loss based on foot contact data in the joint position ground truth and a sample foot joint displacement difference between adjacent frames in the sample joint position; and
determining the model prediction loss based on at least one of the motion prediction loss, the speed loss, the joint position loss, or the foot contact loss.

13. The method according to claim 11, wherein the denoising the set of sample noisy motion parameters comprises:
setting the set of sample past motion parameters to zero based on a parameter zero-setting probability; and
performing one of:
denoising, when the set of sample past motion parameters is not set to zero, the set of sample noisy motion parameters through the motion diffusion model based on the set of sample past motion parameters and the set of sample control parameters, to obtain the set of sample motion parameters; or
denoising, when the set of sample past motion parameters is set to zero, the set of sample noisy motion parameters through the motion diffusion model based on the set of sample control parameters, to obtain the set of sample motion parameters.

14. An object control apparatus, comprising:
processing circuitry configured to:
obtain a set of past motion parameters and a set of control parameters, the set of past motion parameters being from a previous motion prediction round and representing a past motion performed by a controlled object before a current motion prediction round, and the set of control parameters representing a motion expectation and a movement trajectory prediction for the controlled object in the current motion prediction round;
generate a set of noisy motion parameters based on sampling a Gaussian noise;
generate a set of expected motion parameters for the current motion prediction round through a motion diffusion model based on the set of noisy motion parameters, the set of past motion parameters, and the set of control parameters; and
control a current motion of the controlled object based on the set of expected motion parameters for the current motion prediction round.

15. The object control apparatus according to claim 14, wherein
the set of control parameters includes a motion style label, a root joint displacement trajectory, and a motion orientation, the motion style label indicating a motion style of the controlled object, the root joint displacement trajectory indicating the movement trajectory prediction of the controlled object, and the motion orientation indicating a movement orientation of the controlled object; and
the processing circuitry is configured to:
encode, through a feature mapping layer of the motion diffusion model, the set of past motion parameters to obtain a past motion feature;
encode the motion style label to obtain a motion style feature;
encode the root joint displacement trajectory to obtain a root joint displacement feature;
encode the motion orientation to obtain a motion orientation feature;
denoise the set of noisy motion parameters through the motion diffusion model based on the past motion feature, the motion style feature, the root joint displacement feature, and the motion orientation feature, to obtain a first set of denoised motion parameters; and
obtain the set of expected motion parameters for the current motion prediction round based on the first set of denoised motion parameters.

16. The object control apparatus according to claim 15, wherein
the motion diffusion model includes a plurality of feature mapping layers; and
the set of past motion parameters, the motion style label, the root joint displacement trajectory, and the motion orientation respectively correspond to different feature mapping layers of the plurality of feature mapping layers.

17. The object control apparatus according to claim 15, wherein the processing circuitry is configured to:
determine whether the motion style label for the current motion prediction round is consistent with a previous motion style label for the previous motion prediction round; and
determine the first set of denoised motion parameters as the set of expected motion parameters for the current motion prediction round when the motion style label is determined as consistent with the previous motion style label.

18. The object control apparatus according to claim 17, wherein the processing circuitry is configured to:
denoise the set of noisy motion parameters through the motion diffusion model based on the past motion feature being set to zero, the motion style feature, the root joint displacement feature, and the motion orientation feature, to obtain a second set of denoised motion parameters when the motion style label is determined as inconsistent with the previous motion style label; and
determine the set of expected motion parameters for the current motion prediction round based on the first set of denoised motion parameters and the second set of denoised motion parameters when the motion style label is determined as inconsistent with the previous motion style labels.

19. The object control apparatus according to claim 14, wherein
the set of expected motion parameters includes N frames of target root joint coordinates and N frames of joint rotation parameters, N being a positive integer;
the processing circuitry is configured to:
control the current motion of the controlled object based on first M frames of target root joint coordinates and first M frames of joint rotation parameters in the set of expected motion parameters, M being a positive integer less than N; and
project the N frames of target root joint coordinates to N frames of target root joint displacement points in a coordinate plane to obtain a target root joint displacement trajectory;
obtain a root joint expansion trajectory through trajectory expansion based on last N−M frames of target root joint displacement points in the target root joint displacement trajectory, the root joint expansion trajectory including M frames of root joint expansion displacement points; and
determine a root joint displacement trajectory for a next motion prediction round based on the last N−M frames of target root joint displacement points and the M frames of root joint expansion displacement points.

20. A non-transitory computer-readable storage medium storing instructions, which when executed by a processor, cause the processor to perform an object control method, the method comprising:
obtaining a set of past motion parameters and a set of control parameters, the set of past motion parameters being from a previous motion prediction round and representing a past motion performed by a controlled object before a current motion prediction round, and the set of control parameters representing a motion expectation and a movement trajectory prediction for the controlled object in the current motion prediction round;
generating a set of noisy motion parameters based on sampling a Gaussian noise;
generating a set of expected motion parameters for the current motion prediction round through a motion diffusion model based on the set of noisy motion parameters, the set of past motion parameters, and the set of control parameters; and
controlling a current motion of the controlled object based on the set of expected motion parameters for the current motion prediction round.
